(19) United States
(12) Patent Application Publication
(10) Pub. No.: US 2026/0111847 A1
(43) Pub. Date: Apr. 23, 2026

(54) GOVERNMENT DATA ANALYSIS AND ASSOCIATED SYSTEMS, METHODS, AND NON-TRANSITORY COMPUTER-READABLE MEDIA

(71) Applicant: NationGraph Inc., Dover, DE (US)

(72) Inventors: Kimia Hamidi, Miami, FL (US); Yi Cheng Ding, Richmond (CA)

(73) Assignee: NationGraph Inc., Dover, DE (US)

(21) Appl. No.: 19/364,795

(22) Filed: Oct. 21, 2025

Related U.S. Application Data
(60) Provisional application No. 63/709,753, filed on Oct. 21, 2024.

(51) Int. Cl. G06Q 10/101; G06F 16/334; G06F 16/951; G06F 40/289

(52) U.S. Cl. CPC G06Q 10/101; G06F 16/3347; G06F 16/951; G06F 40/289

(57) ABSTRACT

A government data analysis system that may aggregate the data of government entities in state and local education (SLED), such as K-12 schools, K-12 school districts, and higher education institutions, and process and store the data. The government data analysis system may provide, enable, or facilitate various functionality for the data, such as artificial intelligence-assisted research, analysis, procurement, compliance and other functionality. The government data analysis system may generate workspaces for users that combine data for numerous government entities in SLED that would otherwise be separate. Such data may include strategic plans, meeting materials (for example, school board agendas or meeting minutes), budgets, and contact information of the government institutions. The government data analysis system may analyze the data using artificial intelligence systems that include large language models (LLMs) in order to surface actionable insights, signals, and other information to users.

### CROSS-REFERENCE TO RELATED APPLICATION

This application claims priority to and seeks the benefit of U.S. Provisional Patent Application No. 63/709,753, filed on October 21, 2024, and entitled “GOVERNMENT CONTRACTING ASSISTANCE,” the entirety of which is incorporated by reference herein in its entirety.

### TECHNICAL FIELD

The present disclosure relates in general to data of government institutions, and in particular to aggregating government institution data and facilitate or providing research, analysis, and other uses of government institution data.

### BACKGROUND

There are over 100,000 state and local education (SLED) entities, such as K-12 schools, K-12 school districts, and higher education institutions, in the United States. As governmental bodies, SLED entities are typically required to make their information, such as information about their operations (for example, budgets, contracts, communications, policies, or meeting minutes) publicly available. However, there is no single standard for providing SLED entity data, and thus such data may be in a variety of formats and presented in many different ways. Moreover, each SLED entity may make its data available via a different publicly accessible system, or may only make its data available in response to freedom of information act (FOIA) requests.

The same issues also apply to the data of other governmental bodies in the United States, such as state agencies, counties, municipalities, public safety agencies, and transit agencies.

### SUMMARY

In some aspects, the techniques described herein relate to a method including: receiving multiple sets of data for multiple government institutions, a set of data for a government institution including profile data of the government institution and one or more of contact information of one or more individuals associated with the government institution, one or more meeting materials of the government institution, or one or more budgets of the government institution; for each set of data of the multiple sets of data: generating, based on the data in the set, multiple data segments; generating, based on the multiple data segments, multiple vectors, a vector representing a data segment; and storing the multiple data segments and the multiple vectors; receiving a request to generate a workspace that includes one or more particular government institutions of the multiple government institutions; generating the workspace, the workspace including the one or more particular government institutions and the profile data of the one or more particular government institutions; providing the workspace for display; receiving a request to add data for the one or more particular government institutions to the workspace; generating, based on the request, a search vector; identifying, based on the search vector, one or more particular vectors of the multiple vectors; identifying, based on the one or more particular vectors, one or more particular data segments of the multiple data segments; generating, based on the request, one or more inputs for one or more artificial intelligence models; providing the one or more inputs and the one or more particular data segments to the one or more artificial intelligence models; receiving one or more responses from the one or more artificial intelligence models; generating, based on the one or more responses, the data for the one or more particular government institutions; and adding the data for the one or more particular government institutions to the workspace.

In some aspects, the techniques described herein relate to a method, further including: receiving a request to monitor a corpus for information relevant to one or more keywords or search queries; monitoring the corpus using the one or more keywords or search queries; determining, based on the monitoring, that the corpus includes information relevant to the one or more keywords or search queries; generating, based on the information relevant to the one or more keywords or search queries, one or more signals; and providing the one or more signals for display.

In some aspects, the techniques described herein relate to a method wherein the data for the one or more particular government institutions includes contact information for one or more individuals associated with the one or more particular government institutions, and further including: receiving a request to display or export the contact information for the one or more individuals; and providing the contact information for the one or more individuals for display or export.

In some aspects, the techniques described herein relate to a method wherein receiving the multiple sets of data for the multiple government institutions includes: receiving, for at least one government institution of the multiple government institutions, freedom of information act (FOIA) request information that is usable to generate a FOIA request for information of the at least one government institution; generating, based on the FOIA request information, a FOIA request for the information of the at least one government institution; submitting the FOIA request for the information of the at least one government institution; and receiving, in response to the FOIA request, at least one set of information of the at least one government institution.

In some aspects, the techniques described herein relate to a method, further including: receiving a request to submit a FOIA request for information of at least one particular government institution of the one or more particular government institutions; accessing FOIA request information that is usable to generate a FOIA request for information of the at least one particular government institution; generating, based on the request and the FOIA request information, the FOIA request for the information of the at least one particular government institution; submitting the FOIA request for the information of the at least one particular government institution; receiving, in response to the FOIA request, the information of the at least one particular government institution; and providing the information of the at least one particular government institution for display.

In some aspects, the techniques described herein relate to a method wherein receiving the multiple sets of data for the multiple government institutions includes obtaining, using multiple web crawlers, the multiple sets of data for the multiple government institutions from multiple government data systems.

In some aspects, the techniques described herein relate to a method, further including: receiving a request to add one or more intent scores for the one or more particular government institutions to the workspace; generating, based on the request, one or more inputs to the one or more artificial intelligence models, the one or more inputs including one or more requests to generate the one or more intent scores; receiving one or more responses from the one or more artificial intelligence models, the one or more responses including the one or more intent scores; and adding the one or more intent scores for the one or more particular government institutions to the workspace.

In some aspects, the techniques described herein relate to a method wherein the request to add data to the workspace for the one or more particular government institutions includes a prompt, and generating, based on the request, the one or more inputs for the one or more artificial intelligence models includes generating, based on the prompt, the one or more inputs for the one or more artificial intelligence models.

In some aspects, the techniques described herein relate to a method, further including: receiving multiple requests for proposal for at least some of the multiple government institutions; storing the multiple requests for proposal; receiving a search request to search the multiple requests for proposal; identifying, based on the search request, one or more particular requests for proposal of the multiple requests for proposal; and providing the one or more particular requests for proposal for display.

In some aspects, the techniques described herein relate to a method, further including: receiving a request to add an email or a call script for the one or more particular government institutions to the workspace; generating, based on the request, one or more inputs to the one or more artificial intelligence models, the one or more inputs including one or more requests to generate one or more emails or call scripts; receiving one or more responses from the one or more artificial intelligence models, the one or more responses including the one or more emails or call scripts; and adding the one or more emails or call scripts for the one or more particular government institutions to the workspace.

In some aspects, the techniques described herein relate to one or more non-transitory computer-readable media including executable instructions that when executed by one or more processors of a system cause the system to perform a method including: receiving multiple sets of data for multiple government institutions, a set of data for a government institution including profile data of the government institution and one or more of contact information of one or more individuals associated with the government institution, one or more meeting materials of the government institution, or one or more budgets of the government institution; for each set of data of the multiple sets of data: generating, based on the data in the set, multiple data segments; generating, based on the multiple data segments, multiple vectors, a vector representing a data segment; and storing the multiple data segments and the multiple vectors; receiving a request to generate a workspace that includes one or more particular government institutions of the multiple government institutions; generating the workspace, the workspace including the one or more particular government institutions and the profile data of the one or more particular government institutions; providing the workspace for display; receiving a request to add data for the one or more particular government institutions to the workspace; generating, based on the request, a search vector; identifying, based on the search vector, one or more particular vectors of the multiple vectors; identifying, based on the one or more particular vectors, one or more particular data segments of the multiple data segments; generating, based on the request, one or more inputs for one or more artificial intelligence models; providing the one or more inputs and the one or more particular data segments to the one or more artificial intelligence models; receiving one or more responses from the one or more artificial intelligence models; generating, based on the one or more responses, the data for the one or more particular government institutions; and adding the data for the one or more particular government institutions to the workspace.

In some aspects, the techniques described herein relate to one or more non-transitory computer-readable media, the method further including: receiving a request to monitor a corpus for information relevant to one or more keywords or search queries; monitoring the corpus using the one or more keywords or search queries; determining, based on the monitoring, that the corpus includes information relevant to the one or more keywords or search queries; generating, based on the information relevant to the one or more keywords or search queries, one or more signals; and providing the one or more signals for display.

In some aspects, the techniques described herein relate to one or more non-transitory computer-readable media wherein the data for the one or more particular government institutions includes contact information for one or more individuals associated with the one or more particular government institutions, and the method further including: receiving a request to display or export the contact information for the one or more individuals; and providing the contact information for the one or more individuals for display or export.

In some aspects, the techniques described herein relate to one or more non-transitory computer-readable media wherein receiving the multiple sets of data for the multiple government institutions includes: receiving, for at least one government institution of the multiple government institutions, freedom of information act (FOIA) request information that is usable to generate a FOIA request for information of the at least one government institution; generating, based on the FOIA request information, a FOIA request for the information of the at least one government institution; submitting the FOIA request for the information of the at least one government institution; and receiving, in response to the FOIA request, at least one set of information of the at least one government institution.

In some aspects, the techniques described herein relate to one or more non-transitory computer-readable media, the method further including: receiving a request to submit a FOIA request for information of at least one particular government institution of the one or more particular government institutions; accessing FOIA request information that is usable to generate a FOIA request for information of the at least one particular government institution; generating, based on the request and the FOIA request information, the FOIA request for the information of the at least one particular government institution; submitting the FOIA request for the information of the at least one particular government institution; receiving, in response to the FOIA request, the information of the at least one particular government institution; and providing the information of the at least one particular government institution for display.

In some aspects, the techniques described herein relate to one or more non-transitory computer-readable media wherein receiving the multiple sets of data for the multiple government institutions includes obtaining, using multiple web crawlers, the multiple sets of data for the multiple government institutions from multiple government data systems.

In some aspects, the techniques described herein relate to one or more non-transitory computer-readable media, the method further including: receiving a request to add one or more intent scores for the one or more particular government institutions to the workspace; generating, based on the request, one or more inputs to the one or more artificial intelligence models, the one or more inputs including one or more requests to generate the one or more intent scores; receiving one or more responses from the one or more artificial intelligence models, the one or more responses including the one or more intent scores; and adding the one or more intent scores for the one or more particular government institutions to the workspace.

In some aspects, the techniques described herein relate to one or more non-transitory computer-readable media wherein the request to add data to the workspace for the one or more particular government institutions includes a prompt, and generating, based on the request, the one or more inputs for the one or more artificial intelligence models includes generating, based on the prompt, the one or more inputs for the one or more artificial intelligence models.

In some aspects, the techniques described herein relate to one or more non-transitory computer-readable media, the method further including: receiving multiple requests for proposal for at least some of the multiple government institutions; storing the multiple requests for proposal; receiving a search request to search the multiple requests for proposal; identifying, based on the search request, one or more particular requests for proposal of the multiple requests for proposal; and providing the one or more particular requests for proposal for display.

In some aspects, the techniques described herein relate to a system including at least one processor and at least one memory including executable instructions that when executed by the at least one processor cause the system to: receive multiple sets of data for multiple government institutions, a set of data for a government institution including profile data of the government institution and one or more of contact information of one or more individuals associated with the government institution, one or more meeting materials of the government institution, or one or more budgets of the government institution; for each set of data of the multiple sets of data: generate, based on the data in the set, multiple data segments; generate, based on the multiple data segments, multiple vectors, a vector representing a data segment; and store the multiple data segments and the multiple vectors; receive a request to generate a workspace that includes one or more particular government institutions of the multiple government institutions; generate the workspace, the workspace including the one or more particular government institutions and the profile data of the one or more particular government institutions; provide the workspace for display; receive a request to add data for the one or more particular government institutions to the workspace; generate, based on the request, a search vector; identify based on the search vector, one or more particular vectors of the multiple vectors; identify, based on the one or more particular vectors, one or more particular data segments of the multiple data segments; generate, based on the request, one or more inputs for one or more artificial intelligence models; provide the one or more inputs and the one or more particular data segments to the one or more artificial intelligence models; receive one or more responses from the one or more artificial intelligence models; generate, based on the one or more responses, the data for the one or more particular government institutions; and add the data for the one or more particular government institutions to the workspace.

### BRIEF DESCRIPTION OF THE DRAWINGS

FIG. 1A depicts different types of government institution data that may be obtained by a government data analysis system according to some embodiments.

FIG. 1B depicts different functionality that the government data analysis system may facilitate or provide in some embodiments.

FIG. 2 depicts an example environment in which a government data analysis system according to some embodiments may operate.

FIG. 3 is a block diagram depicting components of the government data analysis system in some embodiments.

FIG. 4A is a flow diagram depicting a method for receiving and processing government data according to some embodiments.

FIG. 4B is a flow diagram depicting a method for generating a workspace and adding data for government institutions to the workspace in some embodiments.

FIGS. 5A-5O depict example interfaces for generating and utilizing workspaces that may be provided by the government data analysis system according to some embodiments.

FIG. 6 depicts an example interface for providing monitors that may be provided by the government data analysis system in some embodiments.

FIG. 7 depicts an example interface for providing signals that may be provided by the government data analysis system according to some embodiments.

FIG. 8 depicts an example interface for providing requests for proposal that may be provided by the government data analysis system in some embodiments.

FIG. 9 depicts an example interface for providing freedom of information action requests that may be provided by the government data analysis system according to some embodiments.

FIG. 10 depicts an example interface for providing news that may be provided by the government data analysis system in some embodiments.

FIGS. 11A-11E depict example interfaces for generating workspaces that may be provided by the government data analysis system according to some embodiments.

FIG. 12 depicts a block diagram of an example digital device according to various embodiments.

Throughout the drawings, like reference numerals will be understood to refer to like parts, components, and structures.

### DETAILED DESCRIPTION

Described herein is a government data analysis system that may aggregate the data of government entities in state and local education (SLED), such as K-12 schools, K-12 school districts, and higher education institutions, and process and store the data. The government data analysis system may provide, enable, or facilitate various functionality for the data, such as artificial intelligence-assisted research, analysis, procurement, compliance, and other functionality.

To obtain the data of the government entities in SLED, the government data analysis system may generate and utilize numerous web crawlers that obtain data from websites or other publicly accessible systems. The government data analysis system may also implement an automated freedom of information act (FOIA) engine that submits FOIA requests to obtain the data of the government entities in SLED. After obtaining the data, the government data analysis system may process the data, such as by normalizing, classifying, and generating metadata for the data, and store the processed data. The processed and stored data thus provides a foundation for other functionality of the government data analysis system.

One example of such functionality is research. The government data analysis system may generate workspaces for users that combine data for numerous government entities in SLED. Such data may include strategic plans, meeting materials (for example, school board agendas or meeting minutes), budgets, and contact information of the government institutions. The government data analysis system may analyze the data using artificial intelligence systems that include large language models (LLMs) in order to surface actionable insights, signals, and other information to users. For example, the government data analysis system may allow users to research what government entities in SLED may intend to procure, how the government entities intend to make such procurements, and who the likely procurement decisions makers are. Users may also utilize the government data analysis system to monitor for information that may be relevant to them, such as information about potential procurement decisions by government entities in SLED or information that may lead to procurements. The government data analysis system may also provide signals to users based on the monitoring that the government data analysis system performs on behalf of the users. The government data analysis system can thus notify users of actionable information at the appropriate time.

The government data analysis system may also allow users to obtain contact information for individuals associated with government entities in SLED based on the goals or requirements of the users. For example, a user may be interested in finding the contact information of employees across multiple government entities in SLED that perform a specific function. Without the government data analysis system, the user would have to manually access a website or other information of each government entity to attempt to find the contact information of the employees. The government data analysis system allows the user to specify in natural language the specific function of the employees and have the aggregated data be searched to identify employees that perform that specific function. The user may then export the contact information, such as to customer relationship management (CRM) software, or may have the government data analysis system generate emails or call scripts for contacting the employees.

The government data analysis system may also provide compliance or other back-office functionality. Government entities in SLED often have numerous requirements that vendors have to comply with in order to be approved to sell to the government institutions. Such requirements may be onerous and difficult for vendors, especially vendors that have never been exposed to such requirements. The government data analysis system may provide compliance functionality to users. For example, the government data analysis system may receive and analyze data pertaining to how other vendors have met compliance requirements of a particular government entity and provide guidance or steps for a new vendor to follow in order to comply with those requirements. As another example, the government data analysis system may identify a particular vendor that is already compliant with a particular government entity and surface that particular vendor for potential acquisition or partnering to a new vendor who would like to sell to that particular government institution. Other approaches for facilitating compliance or other back-office functionality will be apparent.

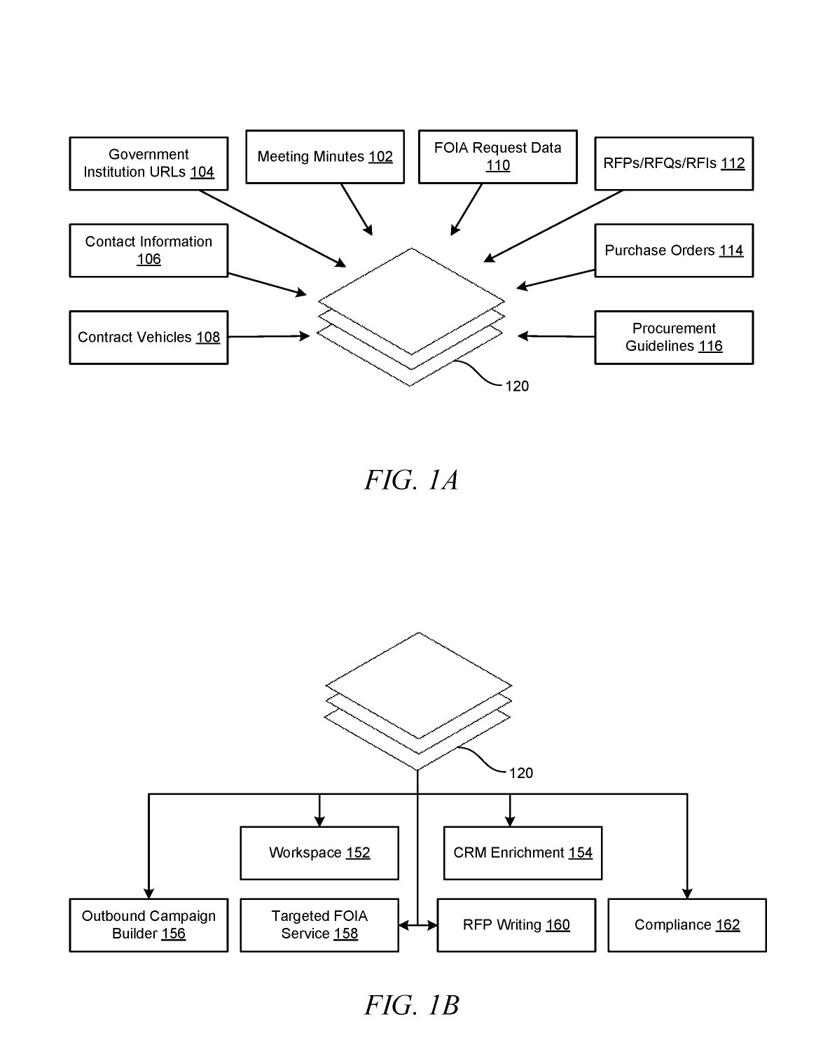

As described in more detail herein, the government data analysis system may obtain data of government entities in SLED using a variety of techniques. FIG. 1A depicts different types of government entity data that the government data analysis system may obtain in some embodiments. The different types of government entity data include meeting minutes 102, government institution URLs 104, contact information 106, contract vehicles 108, FOIA request data 110, requests for proposal (RFP) / requests for quotation (RFQs) / requests for information (RFIs) 112, purchase orders 114, and procurement guidelines 116. The government data analysis system may process and classify the different types of government entity data to generate foundational data layers 120.

The government data analysis system also provides a suite of tools or functionality that leverages the foundational data layers 120. FIG. 1B depicts example tools or functionality that the government data analysis system may provide according to some embodiments based on the foundational data layers 120. The example tools or functionality include a workspace 152, CRM enrichment 154, an outbound campaign builder 156, a targeted FOIA service 158, RFP writing 160, and compliance 162. The government data analysis system may provide tools or functionality other than that depicted in FIG. 1B.

Although many examples of the functionality described herein relate to government entities in SLED, the functionality of the government data analysis system is also applicable to other government entities, such as state agencies, counties, municipalities, public safety agencies, and transit agencies. SLED government entities and non-SLED government entities may be referred to herein as government institutions. Moreover, the functionality of the government data analysis system may also be applicable to non-governmental entities, such as entities in healthcare, life sciences, telecommunications, energy, utilities, manufacturing, finance, or other industries.

Utilizing government institution data presents numerous technical problems. One technical problem is that there are at least hundreds of thousands of government institutions of different types in the United States at the federal, state, and local levels. Each government institution may store data on its own systems or on systems of other entities. Accordingly, government institution data is widely dispersed and therefore presents the technical problem of finding where the data is stored and obtaining the data, and analysis of such government institution data is not efficient nor scalable. Another technical problem is that there is no single standard for storing or presenting government institution data, and thus such data may be in a variety of formats and presented in many different ways. Accordingly, such data is technically difficult to ingest, process, and store in a way that enables important functionality. Another technical problem is that due to the data being largely or entirely unstructured, the data is difficult to analyze and derive actionable insights from.

As described in more detail herein, the government data analysis system provides technical improvements over conventional data aggregation and analysis systems by implementing a novel combination of automated data acquisition techniques (for example, web crawlers and FOIA engines), data normalization and classification processes, and artificial intelligence-assisted research, analysis, procurement, compliance, and other functionality. Unlike generic data processing systems, the government data analysis system is specifically tailored to the unique structure and requirements of government entities in SLED, enabling more efficient and accurate extraction of actionable insights.

Accordingly, the government data analysis system provides numerous technical solutions to the technical problems described herein. The government data analysis system may integrate multiple specialized components that work in concert to achieve its functionality. For example, the government data analysis system may generate one or more web crawlers for each of many government institutions and have the web crawlers obtain the data of the government institutions. A web crawler may be customized for a government institution and thus may be able to obtain the data of the government institution in a way that facilitates later ingestion by the government data analysis system. For data that is not accessible to web crawlers, the government data analysis system may utilize automated FOIA requests to obtain the data. The automated FOIA module is not a generic request submission tool but is designed to intelligently generate and track FOIA requests based on the metadata and classification of government entities.

Once the government data analysis system has obtained the data, the government data analysis system may perform concrete data transformation processes that go beyond mere data collection or display. For instance, the normalization, classification, and metadata generation steps may involve algorithmic processing that converts heterogeneous data formats from various government sources into data according to one or more unified schemas. For example, the government data analysis system may normalize the data through a series of parsing, cleaning, and extraction steps. The government data analysis system may then classify the data using classifications that are well-suited to data for government institutions, such as purchase orders, budgets, strategic plans, RFPs, and contact information. These transformations and classifications may enable downstream functionalities such as CRM enrichment, outbound campaign generation, and compliance guidance.

The government data analysis system may enable users to interact with the data in technologically meaningful ways. For example, users may specify natural language queries to identify government employees performing specific functions across multiple institutions. This capability may be enabled by natural language processing and semantic search algorithms that operate on the structured data layers generated by the government data analysis system. The ability to export contact information to CRM platforms or generate outreach materials further demonstrates that the government data analysis system is not merely organizing information but is providing a technological tool that facilitates real-world actions based on processed data. Similarly, the AI-assisted research functionality leverages large language models (LLMs) in a domain-specific context to identify procurement signals and decision-makers, which would be infeasible using manual or conventional keyword-based search methods. These components are implemented through specific algorithms and data structures that transform raw, unstructured data into structured, actionable intelligence.

While the government data analysis system may be described in the context of SLED government entities, its architecture and functionality are applicable to other domains such as healthcare, energy, and finance. This cross-domain applicability is enabled by the government data analysis system’s modular design and extensible data processing pipelines, which are technological features that allow adaptation to different data environments. The government data analysis system ability to ingest, process, and analyze domain-specific data in a scalable and automated manner is evidence of technological improvements over existing systems. It will be apparent that the government data analysis system may provide other technical improvements and solutions.

The government data analysis system provides numerous advantages. One advantage of is that users may access data of disparate government entities in a unified interface. Another advantage is that users may have access to go to market tools and functionality which may enhance their efforts to market and sell to government institutions. Another advantage is that the users may leverage artificial intelligence to perform research, have questions answered, and surface actionable information. Yet another advantage is that the government data analysis system may assist users with compliance and other back-office functionality, thereby speeding up or improving their delivery of products or services to government institutions. Other advantages will be apparent.

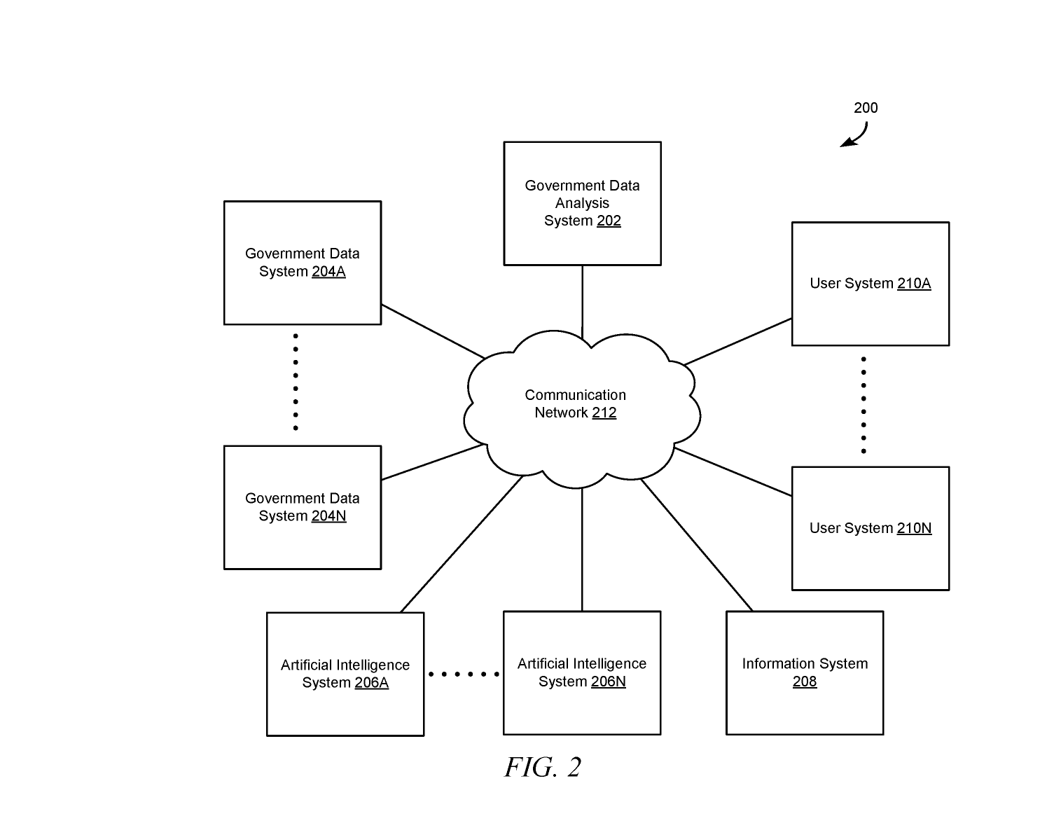

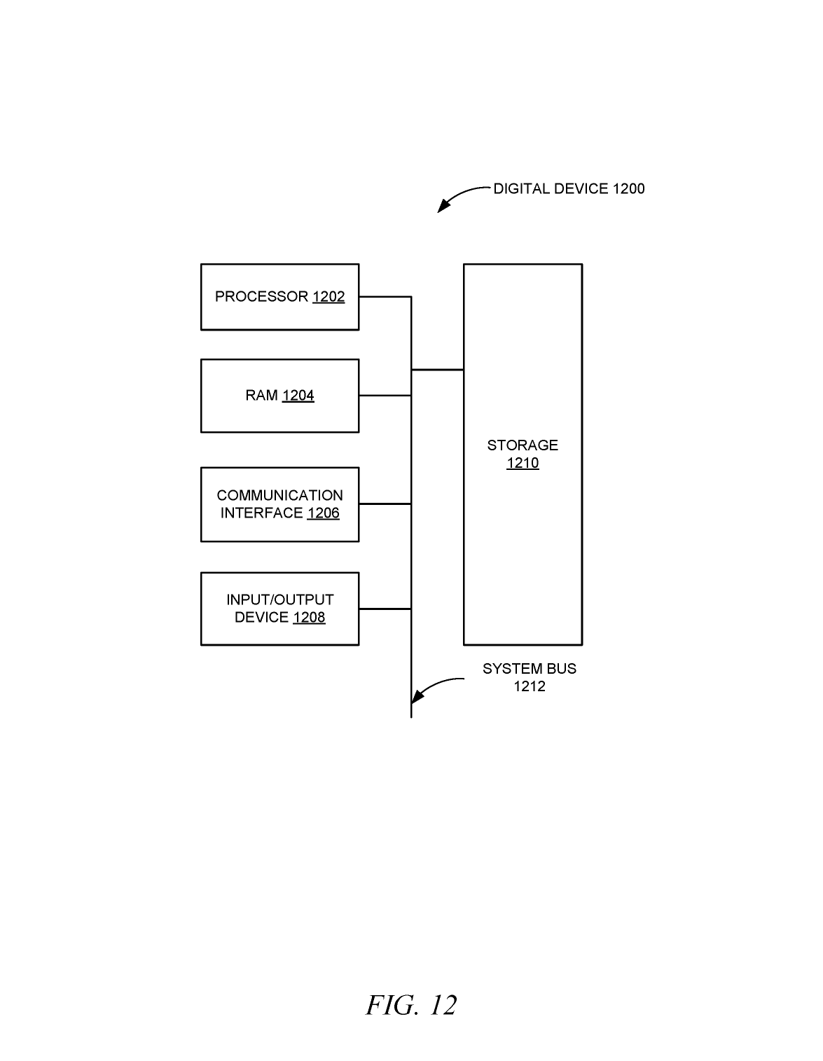

FIG. 2 is a block diagram depicting an example environment 200 in which a government data analysis system as described herein may operate in some embodiments. The environment 200 includes a government data analysis system 202, multiple government data systems 204A through 204N (which may be referred to as a government data system 204 or as government data systems 204), multiple artificial intelligence systems 206A through 206N (which may be referred to as an artificial intelligence system 206 or as artificial intelligence systems 206), an information system 208 and multiple user systems 210A through 210N (which may be referred to as a user system 210 or as user systems 210), and a communication network 212. Each of the government data analysis system 202, the government data system 204, the artificial intelligence systems 206, the information system 208, and the user systems 210 may be or include any number of digital devices. A digital device is any device with at least one processor and memory. Digital devices are discussed further herein, for example, with reference to FIG. 12.

Examples of the government data analysis system 202 are one or more computer servers operated on-premises of an entity operating the government data analysis system 202 or off-premises at a facility operated by another entity. Although the environment 200 depicts a single one of the government data analysis system 202, it is to be understood that there may be multiple of the government data analysis system 202 in various configurations, such as a mixture of on-premises and off-premises at one or more facilities. As described herein, the government data analysis system 202 may receive government data, process the government data for analysis, and generate analyses, insights, signals, scores, or other information based on the government data. The government data analysis system 202 may also provide other functionality, such as generating RFPs, generating FOIA requests, and providing, facilitating, or ensuring compliance processes and procedures.

The government data system 204 may be operated by a government institution, such as a SLED institution (for example, a K-12 school district) or other government entity (for example, a public safety department, a transportation agency, or a public works agency). The government data system 204 may store government data and make the government data accessible to the public, such as through government websites or in response to FOIA requests. The government data system 204 may also be operated by a non-governmental entity that stores government data for or on behalf of government institutions. Examples of a government data system 204 operated by non-governmental entities are Google Drive, BoardBook, and BoardDocs.

The artificial intelligence system 206 may be provided by entities such as OpenAI, Google, Anthropic, Perplexity AI, or Meta. The artificial intelligence system 206 may provide or include artificial intelligence or machine learning models with various capabilities. The artificial intelligence or machine learning models may include generative models, such as LLMs, that have been trained to understand natural language text, software code, or other data. The generative models may receive natural language text as inputs and provide text, such as natural language text or software code, as outputs. The artificial intelligence or machine learning models may also include models that can generate or modify audio, images or video, models that can convert text to speech or speech to text, and models that generate embeddings, such as vectorized embeddings, of documents or of portions of documents. The artificial intelligence system 206 may provide access to artificial intelligence or machine learning models, such as generative models or embedding models, via application programming interfaces (APIs).

The information systems 208 may provide information or services to the government data analysis system 202, such as news services, storage services, product or services information services, or information retrieval services.

The user systems 210 may each include a web browser or other application that is used by a user to access the government data analysis system 202. Users may utilize the user systems 210 to access government data, view analyses, insights, signals, scores, or other information based on the government data, and access other functionality provided by the government data analysis system 202, such as submitting FOIA requests, viewing RFPs, and viewing news or information that may be relevant to or of interest to the users.

In some embodiments, the communication network 212 may represent one or more computer networks (for example, local area networks (LANs), wide area networks (WANs), or the like). The communication network 212 may provide or facilitate communication between any of the government data analysis system 202, the government data system 204, the artificial intelligence system 206, the information system 208, or the user systems 210. In some implementations, the communication network 212 comprises computer devices, routers, cables, or other network topologies. In some embodiments, the communication network 212 may be wired or wireless. In various embodiments, the communication network 212 may comprise the Internet, one or more networks that may be public, private, IP-based, non-IP based, and so forth.

Although the environment 200 depicted in FIG. 2 has a specific configuration and the corresponding description relates to specific functionality and features, it is to be understood that variations of the configuration depicted, or the functionality and features described, are possible. For example, there may be more than one government data analysis system 202. As another example, the government data analysis system 202 may include or provide some or all of the functionality of an artificial intelligence system 206. Accordingly, the disclosure is not limited to the description herein.

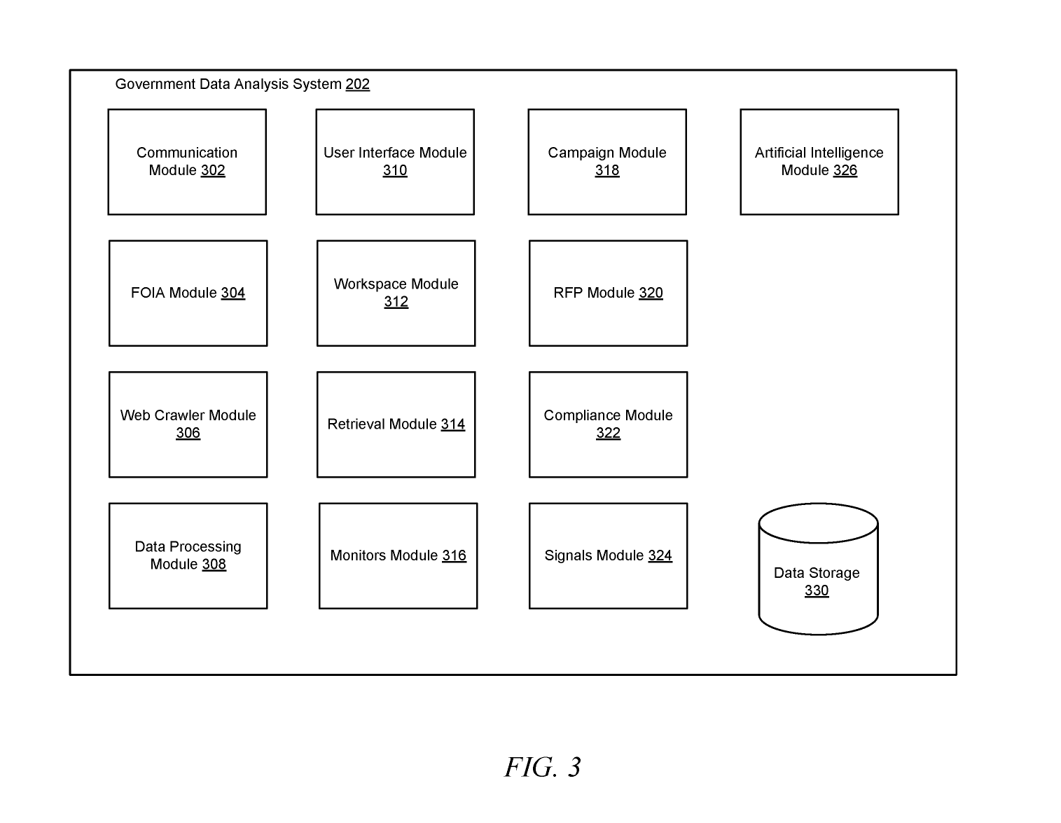

FIG. 3 is a block diagram depicting components of the government data analysis system 202 in some embodiments. The government data analysis system 202 may include a communication module 302, a FOIA module 304, a web crawler module 306, and a data processing module 308. The government data analysis system 202 may also include a user interface module 310, a workspace module 312, a retrieval module 314, and a monitors module 316. The government data analysis system 202 may also include a campaign module 318, an RFP module 320, a compliance module 322, a signals module 324, an artificial intelligence module 326, and a data storage 330.

The communication module 302 may send requests or data between the government data analysis system 202 and any of government data system 204, the artificial intelligence system 206, the information system 208, or the user systems 210.

The FOIA module 304 may receive information that is usable to generate FOIA requests, such as web-based interfaces, APIs, or other information that specify how the FOIA request is to be made or the content of the FOIA request. A FOIA request includes a public records request or any other request for information of a government institution that may be made publicly available. The FOIA module may utilize such information to generate FOIA requests for specific data of government institutions and submit the FOIA requests to the government institutions. For example, the FOIA module 304 may submit the FOIA requests via the web-based interfaces, the APIs, or using other means to the government institutions. The FOIA module 304 may also receive responses to FOIA requests and provide the responses for display to users of the government data analysis system 202.

The web crawler module 306 may request that an artificial intelligence system 206 generate multiple web crawlers for obtaining data of government institutions. The web crawler module 306 may also execute the web crawlers to obtain data from the government data systems 204 (for example, websites operated by government institutions or websites used by government institutions to store data).

The data processing module 308 may process data to normalize the data. For example, the data processing module 308 may parse data according to its format to extract text, process the extracted text, and map the processed data into a structured schema. The data processing module 308 may also classify data using a classification model or an LLM of an artificial intelligence system 206.

The user interface module 310 may provide the various interfaces described herein for display to users. The workspace module 312 may generate workspaces that users utilize to view data of government institutions and research, analyze, or perform other functions on the data.

The retrieval module 314 may retrieve data from datastores of the government data analysis system 202, such as vector databases or text databases. For example, the retrieval module 314 may generate search vectors based on keywords, search terms, or other input provided by users and utilize the search vectors to identify similar vectors in a vector database. As another example, the retrieval module 314 may use the identified vectors to retrieve data segments that are represented by the identified vectors.

The monitors module 316 may allow users to set up monitors to monitor data for government institutions that may be of interest to the user. The campaign module 318 may generate email or call scripts for contacting individuals associated with government institutions.

The RFP module 320 may allow users to search for and view RFPs of government institutions. The compliance module 322 may assist users in compliance processing. The signals module 324 may provide signals to users based on monitors that the user has set up. The artificial intelligence module 326 may generate requests for an artificial intelligence system 206 based on keywords, search terms, prompts, or other inputs provided by users or by the government data analysis system 202.

The data storage 330 may include data stored, accessed, or modified by any of the modules of the government data analysis system 202. The data storage 330 may include any number of data storage structures such as tables, databases, lists, or the like. The data storage 330 may include data that is stored in memory (for example, random access memory (RAM)), on disk or on solid-state devices, or some combination of in-memory and on-disk or on solid-state devices.

A module of the government data analysis system 202 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in random access memory (RAM) or read-only memory (ROM), or any combination. Software may be executed by one or more processors. Although a limited number of modules are depicted in FIG. 3, there may be any number of modules. Further, individual modules may perform any number of functions, including functions of multiple modules as described herein.

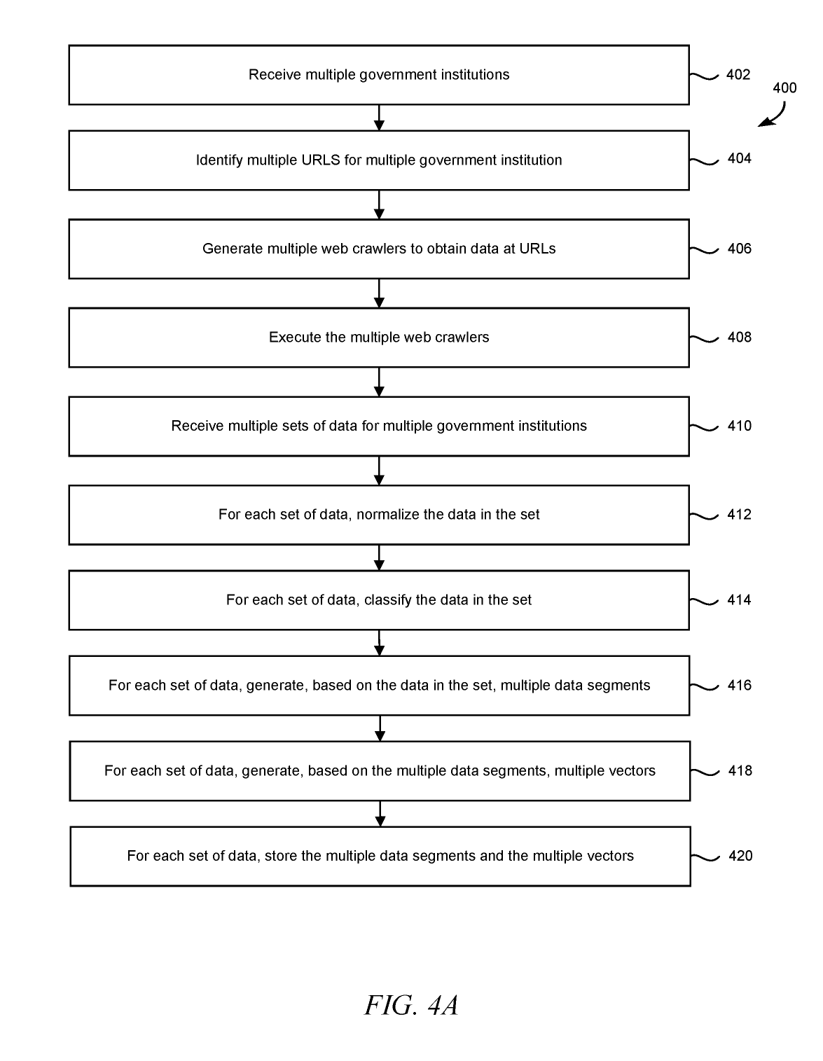

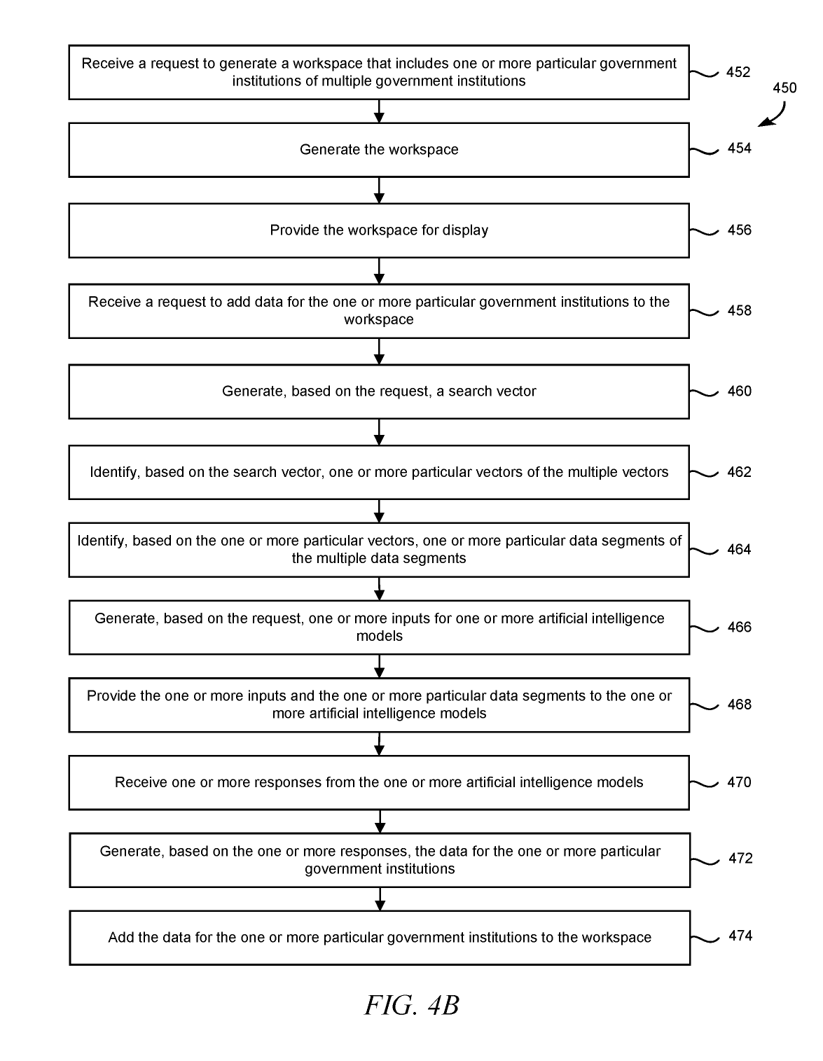

FIG. 4A is a flow diagram depicting a method 400 for receiving and processing government data according to some embodiments. The method 400 may be described in the context of the example environment 200 of FIG. 2. The government data analysis system 202 (for example, various modules of the government data analysis system 202) may perform the method 400. The method 400 may begin at step 402 where the government data analysis system 202 (for example, the retrieval module 314) may receive multiple government institutions, such as a list of multiple government institutions.

A government institution may have a type. A type of a government institution may be a state or a state agency (for example, government institutions at the state level),a county, a municipality, a special district, or a public safety agency (for example, government institutions at the local level), a K-12 school, a K-12 school district, or an institution of higher education (for example, SLED government institutions). A government institution may have a type other than those described herein. The government data analysis system 202 may also receive profile data for the government institutions. Examples of profile data include location data (for example, address data), population data (for example, the number of students in a K-12 school district), the number of schools in a K-12 school district, the district type, the locale category, and other data.

At step 404 the government data analysis system 202 (for example, the retrieval module 314) may identify multiple uniform resource locators (URLs) for the multiple government institutions. A government institution may be associated with zero, one, or more than one URL. For example, a government institution may make data available via two different websites. A URL may be associated one or more than one government institution. For example, multiple government institutions may have their data stored at the same non-governmental entity system, such as Google Drive. At step 406 the government data analysis system 202 (for example, the artificial intelligence module 326) may, for each URL, generate a request to an artificial intelligence system 206 to generate a web crawler to obtain data for government institutions at the URL. The artificial intelligence system 206 may generate a web crawler for each URL and provide the web crawlers to the government data analysis system 202. In some embodiments, the artificial intelligence system 206 may generate several hundred thousand web crawlers.

At step 408 the government data analysis system 202 (for example, the web crawler module 306) may execute the multiple web crawlers to obtain data from the government data systems 204 (for example, websites operated by government institutions or websites used by government institutions to store data). The government data analysis system 202 may execute the multiple web crawlers as cron jobs on a periodic basis or other basis. The government data analysis system 202 may thus update the stored data of government institutions as government institutions publish, change, or modify data. The government data analysis system 202 thereby ensures that users are provided with up to date data and insights. The government data analysis system 202 may store historical data (for example, historical snapshots) so that the historical data is available for research, analysis, or other purposes.

At step 410 the government data analysis system 202 (for example, the web crawler module 306) may receive multiple sets of data for multiple government institutions. The data for a government institution may be or include HTML files, Portable Document Format (PDF) files, Microsoft Word files, Microsoft Excel files, Microsoft PowerPoint files, text files, images, videos, or other types of files. The data may include contact information of one or more individuals associated with the government institution, one or more meeting materials of the government institution, or one or more budgets of the government institution, RFPs for the government institution, or other data. The government data analysis system 202 may perform Optical Character Recognition (OCR) on certain of the received data to recognize text in the received data.

In some embodiments, the government data analysis system 202 (for example, the FOIA module 304) may generate FOIA requests for specific data of government institutions and submit the FOIA requests to the government institutions. For example, the government data analysis system 202 may submit the FOIA requests via web-based interfaces, APIs, or using other means to the government institutions. The generation and submission of FOIA requests by the government data analysis system 202 allows the government data analysis system 202 to obtain data for government institutions, such as data that is not available via the government data systems 204 (for example, data stored in internal databases that is not made available via government institution websites or other government institution interfaces).

At step 412, the government data analysis system 202 (for example, the data processing module 308) may, for each set of data, normalize the data in the set. For example, the government data analysis system 202 may normalize the data in the set through a series of parsing, cleaning, and extraction steps. First, the government data analysis system 202 may parse data according to its format. For example, the government data analysis system 202 may process HTML pages to remove boilerplate elements and extract relevant tags or may parse PDFs to recover readable text and layout information. The government data analysis system 202 may also read CSV or other tabular files directly into structured data frames. Second, the government data analysis system 202 may process the extracted text to standardize it, which may include removing markup, normalizing whitespace, encoding characters consistently, or applying rules to identify and label key fields (for example, names, addresses, dates, or numerical values). Third, the government data analysis system 202 may map the processed data into a structured schema such as JSON objects, database rows, or other record formats. Doing so may enable the processed data to be indexed, searched, or enriched with additional metadata. This normalization process makes heterogeneous data of government institutions consistent and machine-readable, thereby supporting downstream tasks like retrieval, classification, or analysis.

At step 414, the government data analysis system 202 (for example, the data processing module 308) may, for each set of data, classify the data in the set. In some embodiments, the government data analysis system 202 classifies the data using a hybrid approach that involves both a classification model (for example, a lightweight fine-tuned classification model) and an LLM provided by an artificial intelligence system 206. The government data analysis system 202 may utilize the classification model to perform initial labeling based on known templates and metadata (for example, filenames, headers, or recurring patterns such as “Purchase Order #” or “Agenda”). The government data analysis system 202 may then request that an LLM of an artificial intelligence system 206 refine ambiguous or edge cases by analyzing the text semantically and determining the most probable classification. This combination may allow for high-volume, deterministic labeling while maintaining flexibility for new or irregular document types.

As described in more detail herein, the government data analysis system 202 may generate workspaces for users that include government institution data. A workspace may have a table format with columns for the government institution data, such as profile data of the government institutions. The government data analysis system 202 may allow users to add one or more smart columns to the workspaces. A smart column may include the results of an artificial intelligence-assisted search, analysis, or other insight or action that is based on or otherwise utilizes the data of the government institutions. Smart columns are discussed in more detail herein.

In various embodiments, the possible classifications of data may map to smart columns. Possible classifications may include purchase orders, contracts, budgets, meeting minutes or board packets, strategic plans, job postings, contact information, RFPs, bids, or awards, invoices, and policies or handbooks or administrative documents. Each classification may correspond to a semantic document type tag that the government data analysis system 202 may later use to filter or enrich smart columns. The classifications are extensible, in that the government data analysis system 202 may add new classifications or new classifications may be added dynamically, which may occur if new document types are encountered in different government institutions.

At step 416, the government data analysis system 202 (for example, the data processing module 308) may, for each set of data, generate, based on the data in the set, multiple data segments. For example, the government data analysis system 202 may divide or split files into data segments (which may be referred to as chunks) that are smaller and semantically meaningful (for example, paragraphs or 300–1000 tokens). The government data analysis system 202 may employ an LLM or other to divide files into data segments or may utilize heuristics to divide files into data segments. At step 418, the government data analysis system 202 (for example, the data processing module 308) may, for each set of data, generate, based on the multiple data segments, multiple vectors. For example, the government data analysis system 202 may utilize an embedding model to generate a vector (for example, a high-dimensional numerical vector) based on a data segment. The vector may represent the data segment (for example, the vector may encode the semantic meaning of the text of the data segment). At step 420, the government data analysis system 202 (for example, the data processing module 308) may, for each set of data, store the multiple data segments and the multiple vectors. For example, the government data analysis system 202 may store the data segments in a text database (or other suitable datastore) and the vectors, along with metadata, such as identifiers, titles, or source URLs) in a vector database (or other suitable datastore). As the government data analysis system 202 classified data prior to splitting the data into multiple data segments, the data segments may be associated with the classifications, as well as the vectors.

FIG. 4B is a flow diagram depicting a method 450 for generating a workspace and adding data for government institutions to the workspace in some embodiments. The method 450 may be described in the context of the example environment 200 of FIG. 2. The government data analysis system 202 (for example, various modules of the government data analysis system 202) may perform the method 450. The method 450 may begin at step 452 where the government data analysis system 202 (for example, the retrieval module 314) may receive a request to generate a workspace that includes one or more government institutions.

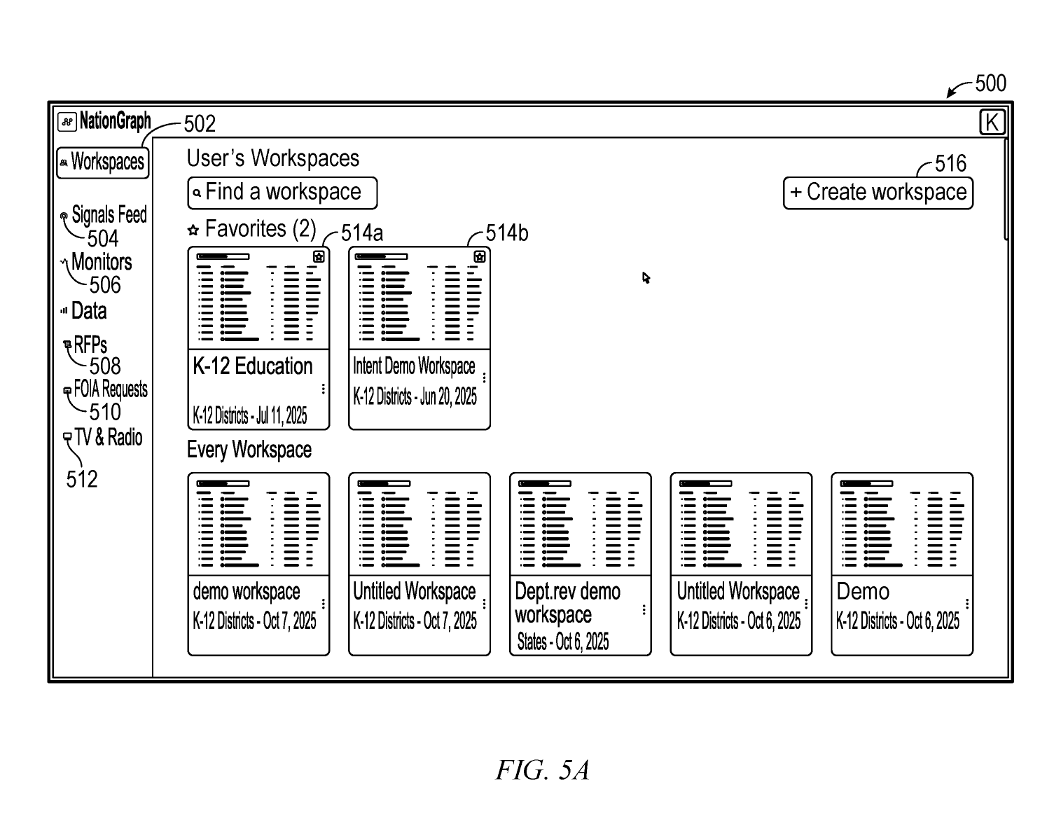

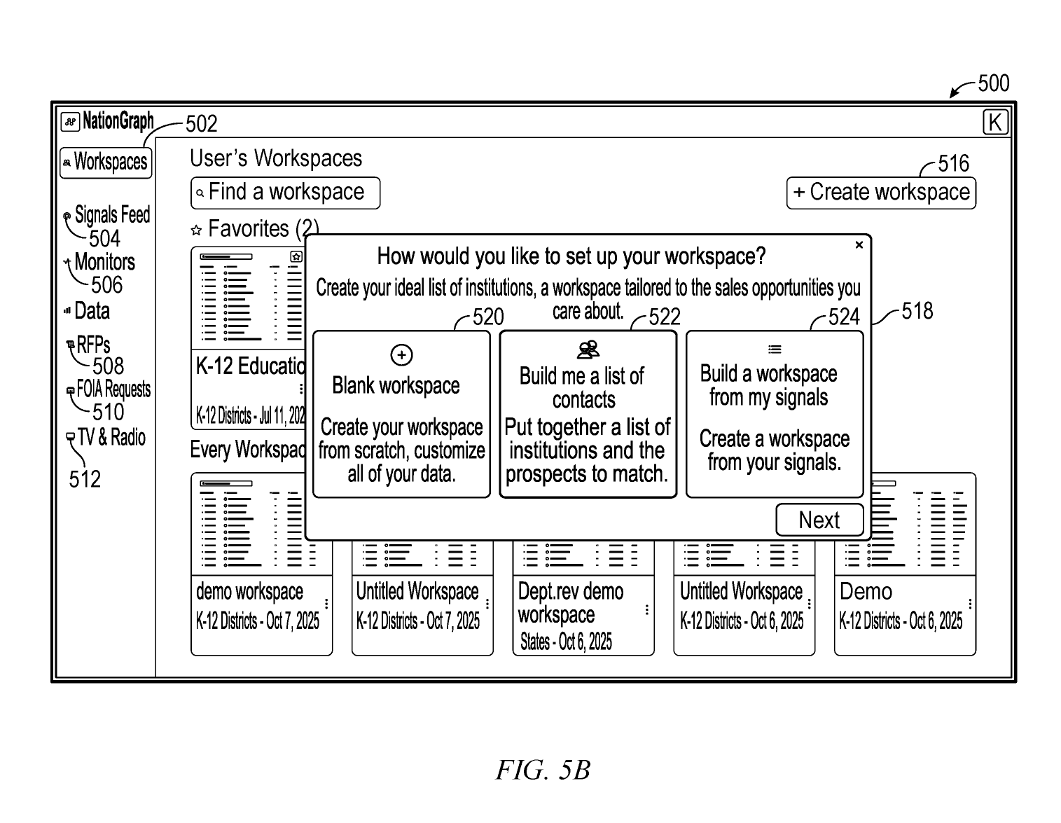

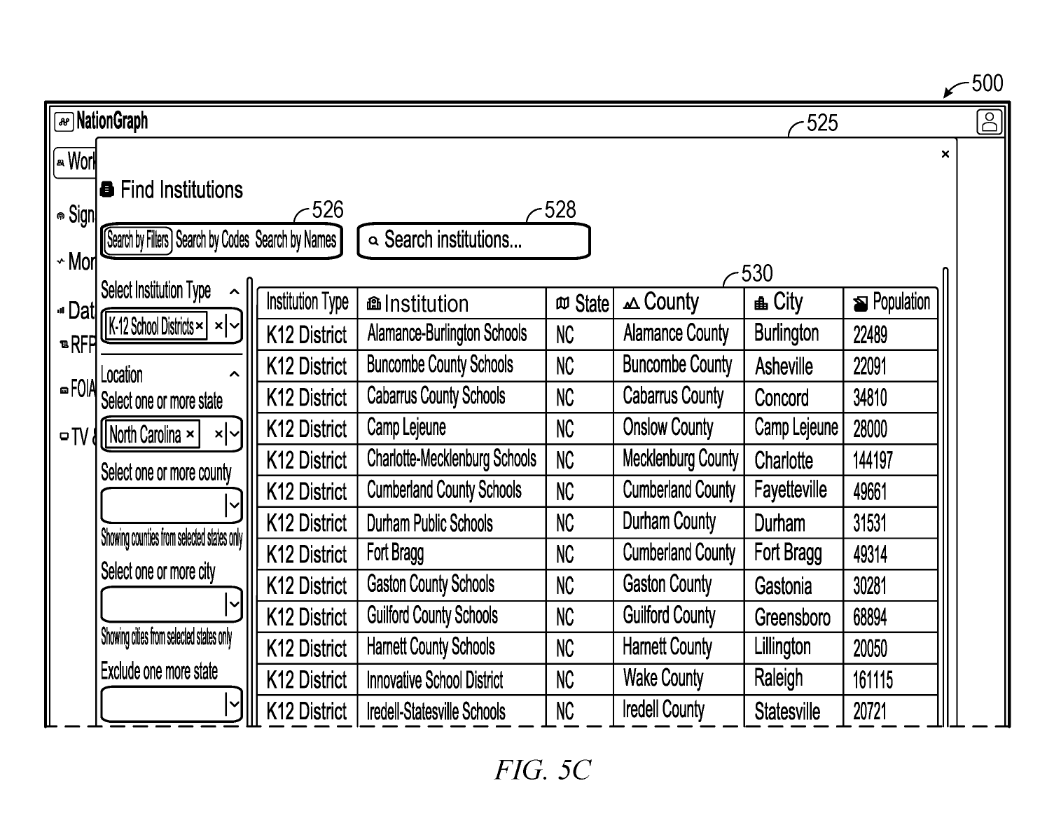

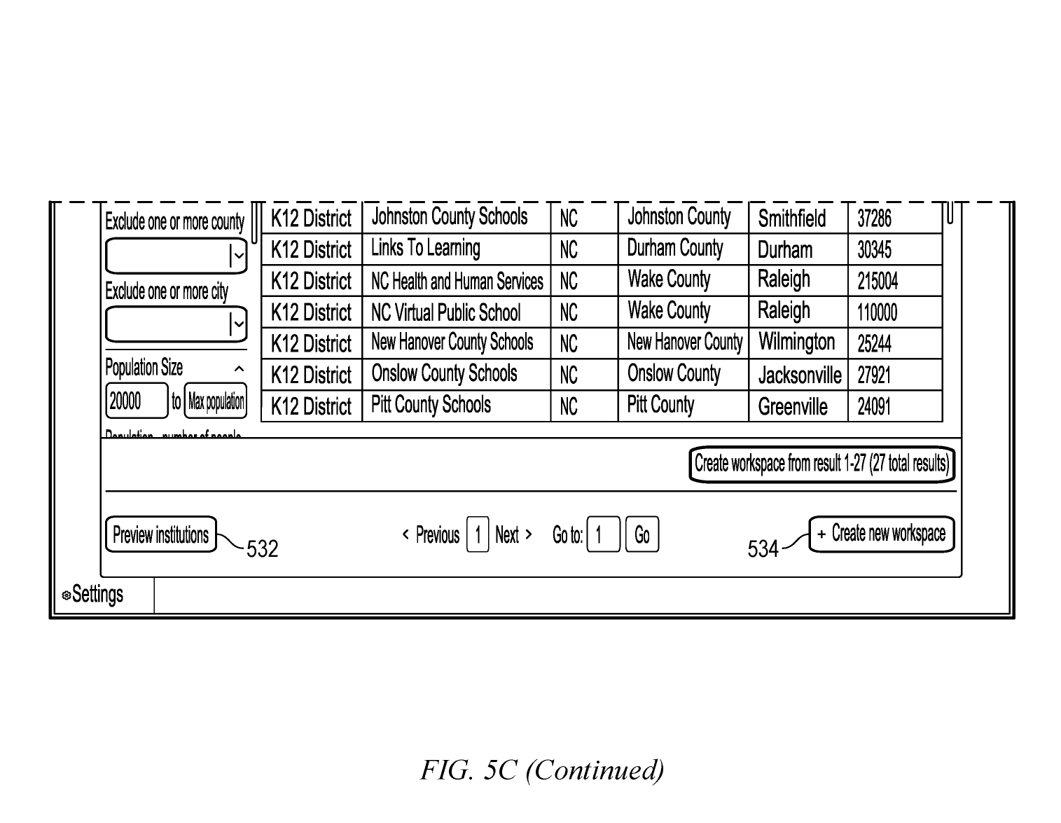

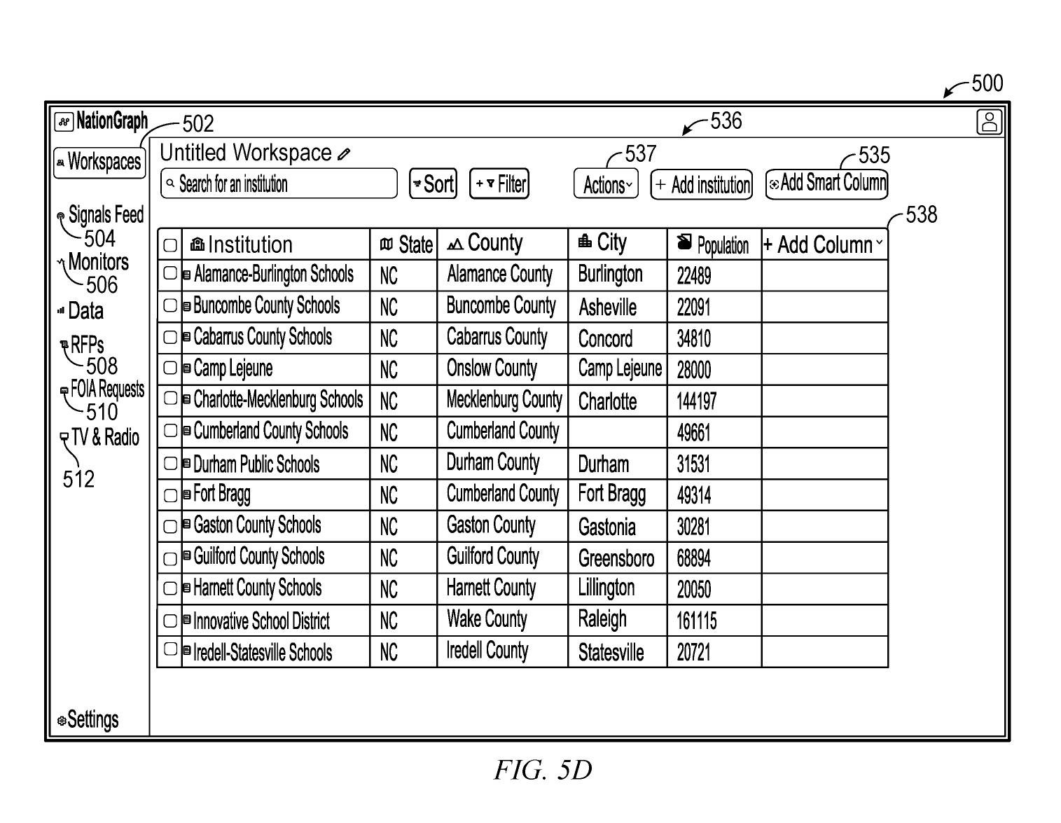

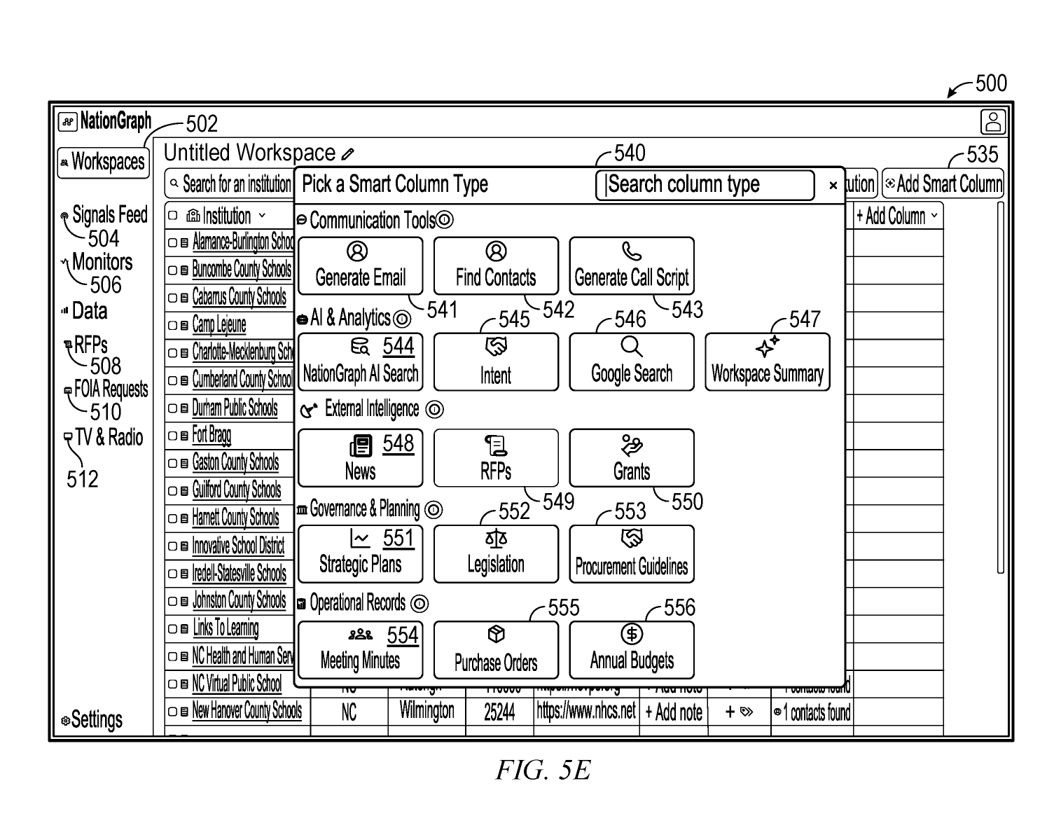

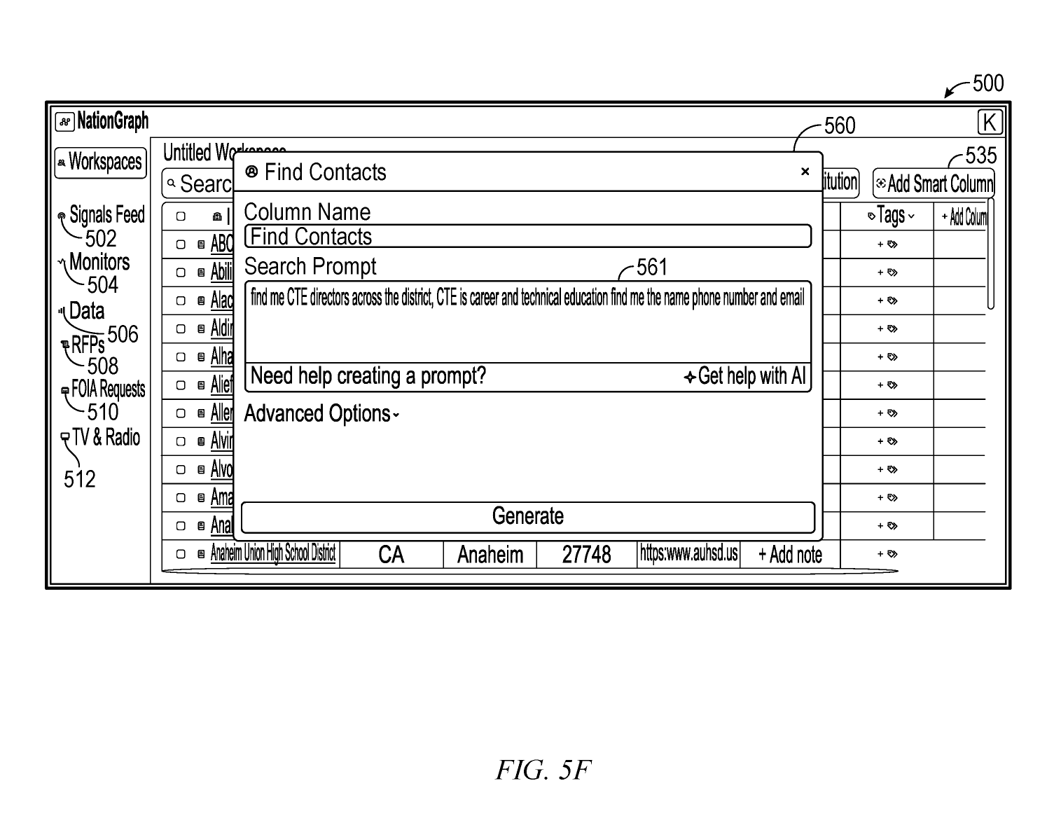

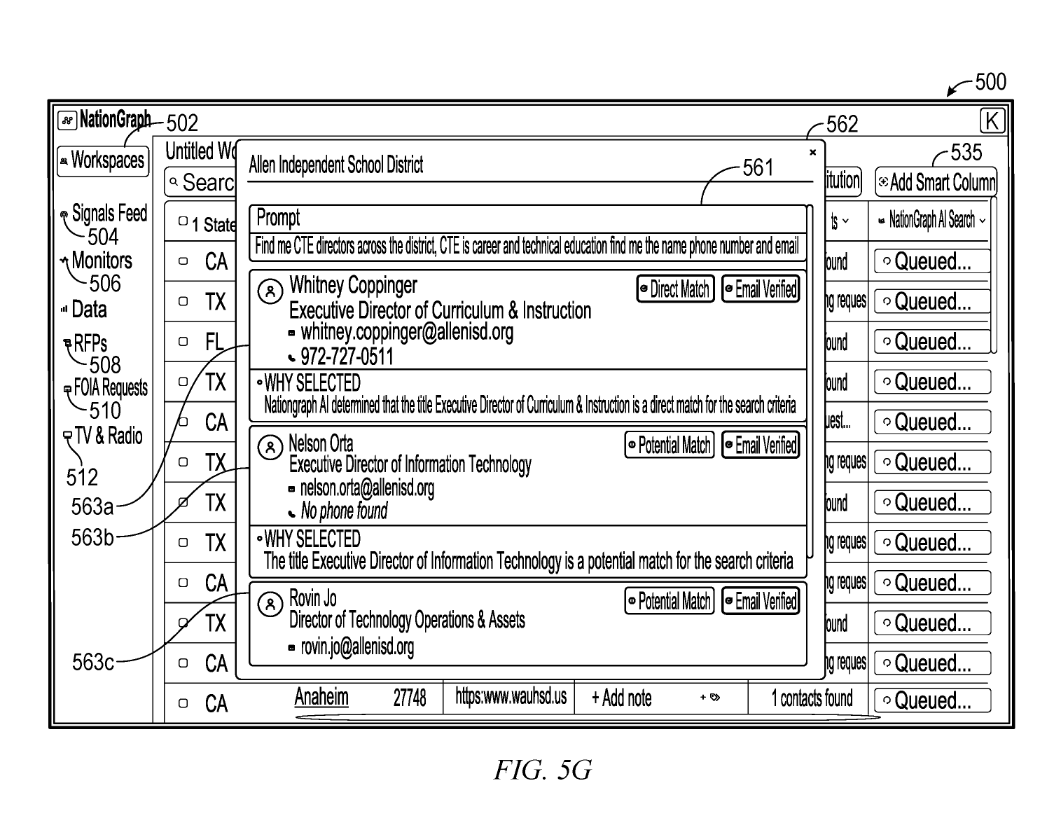

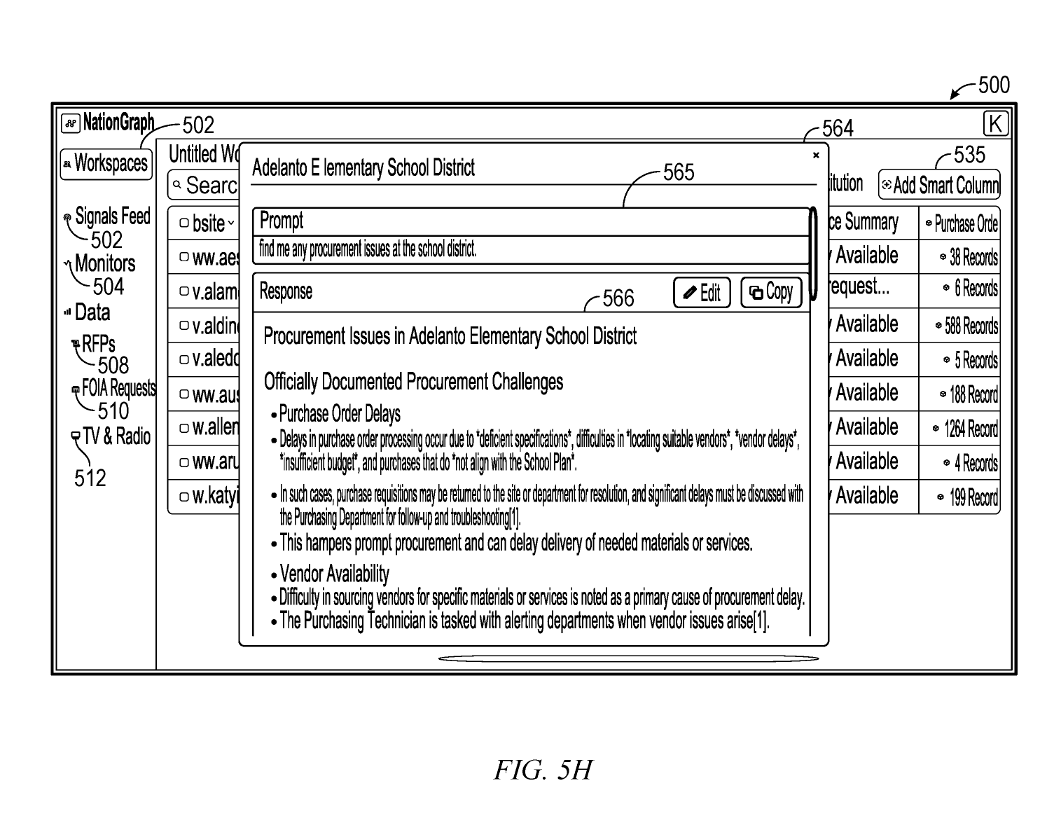

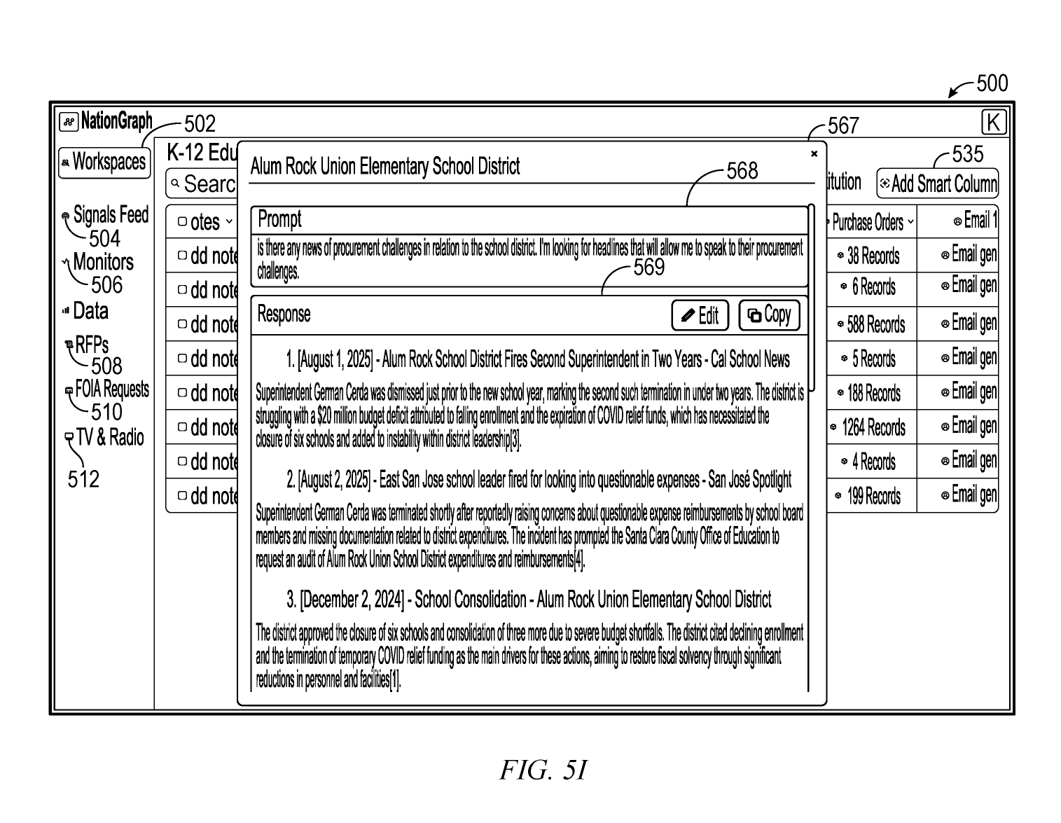

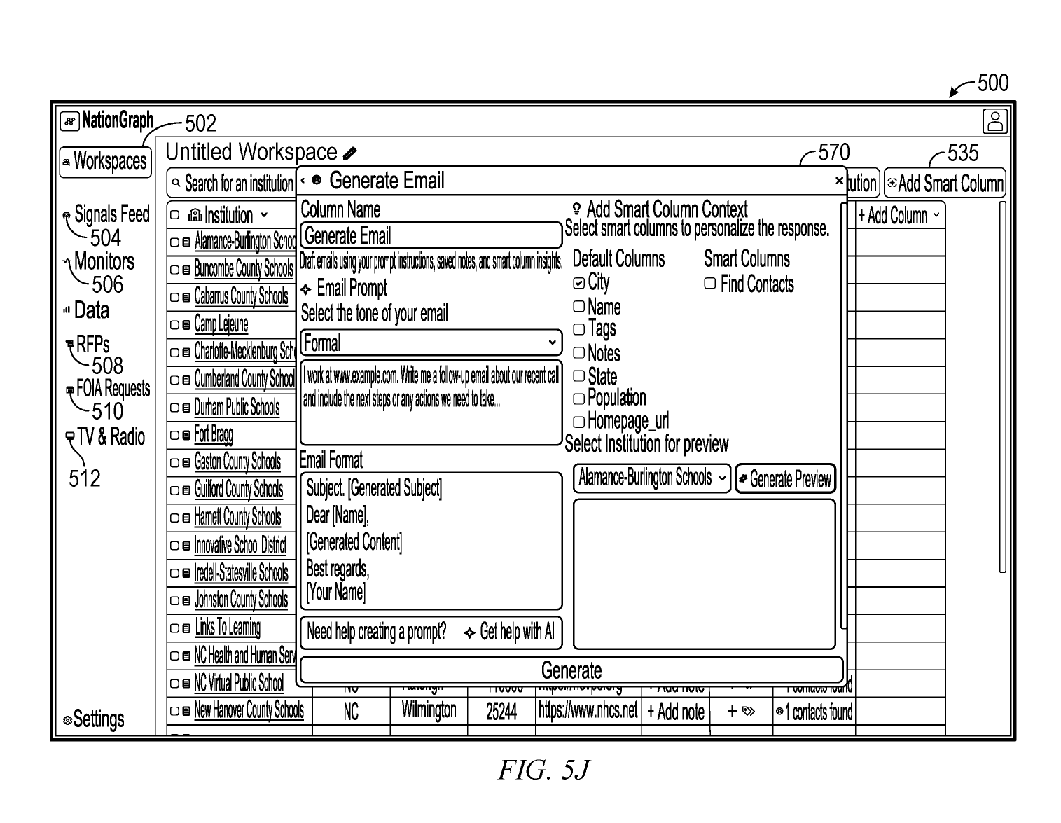

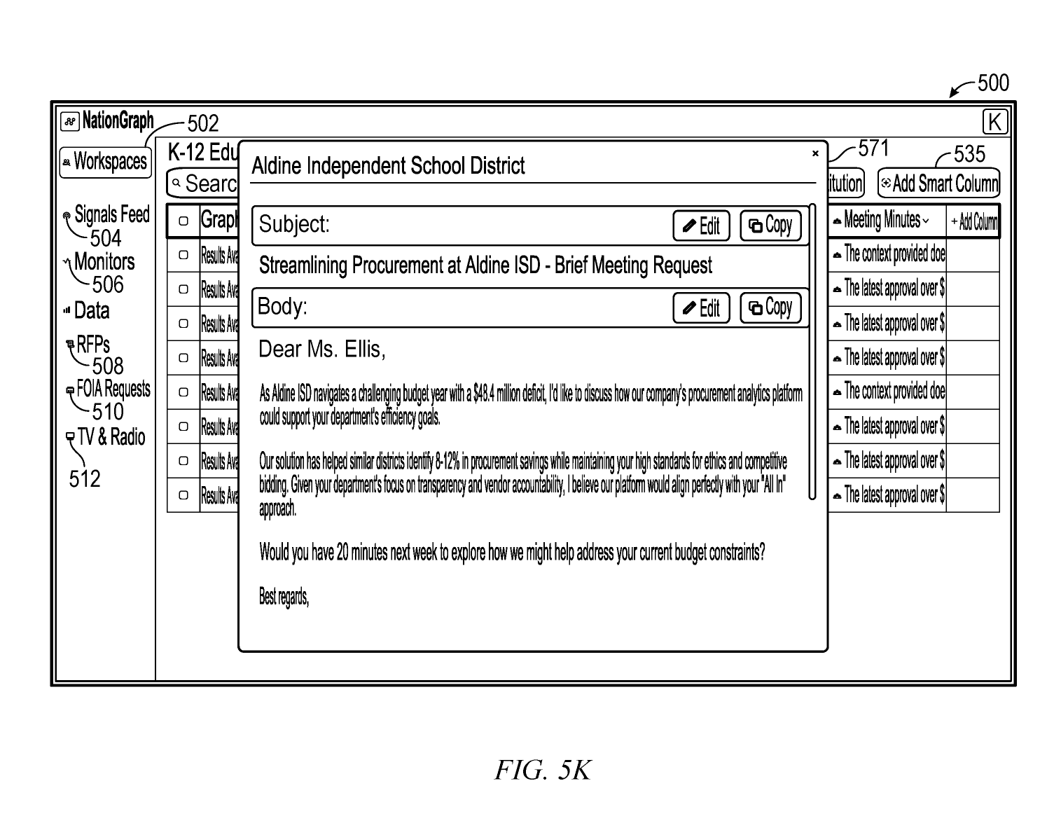

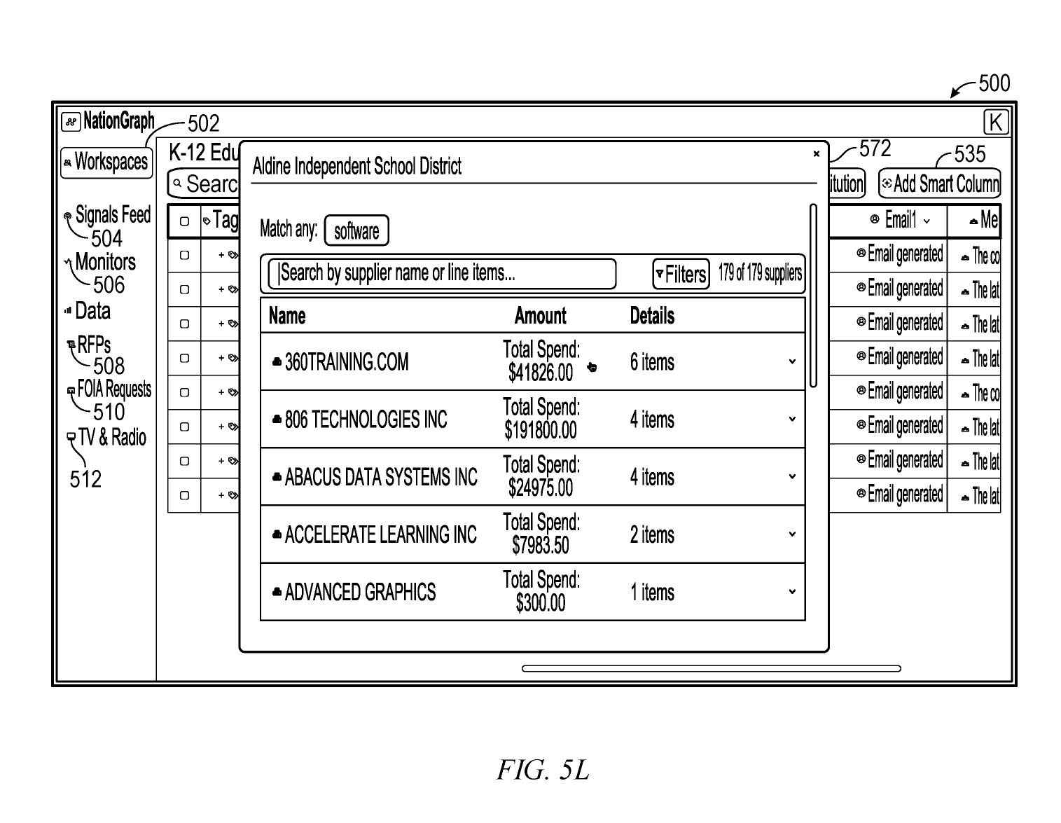

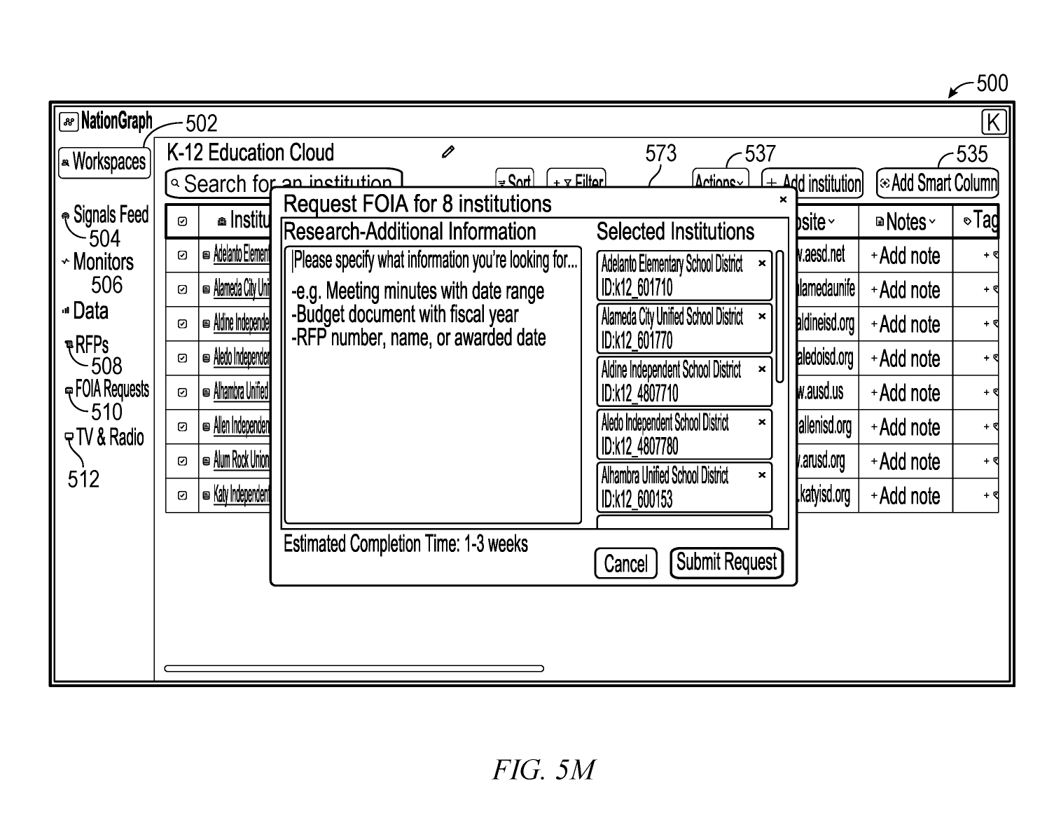

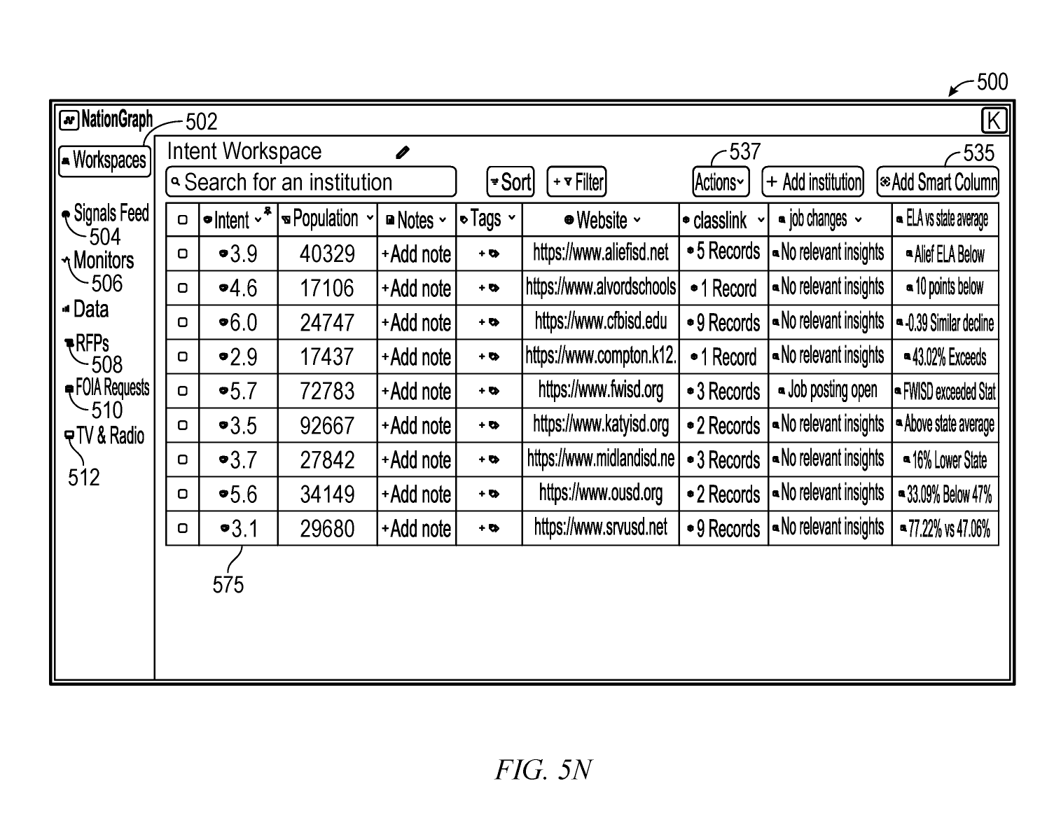

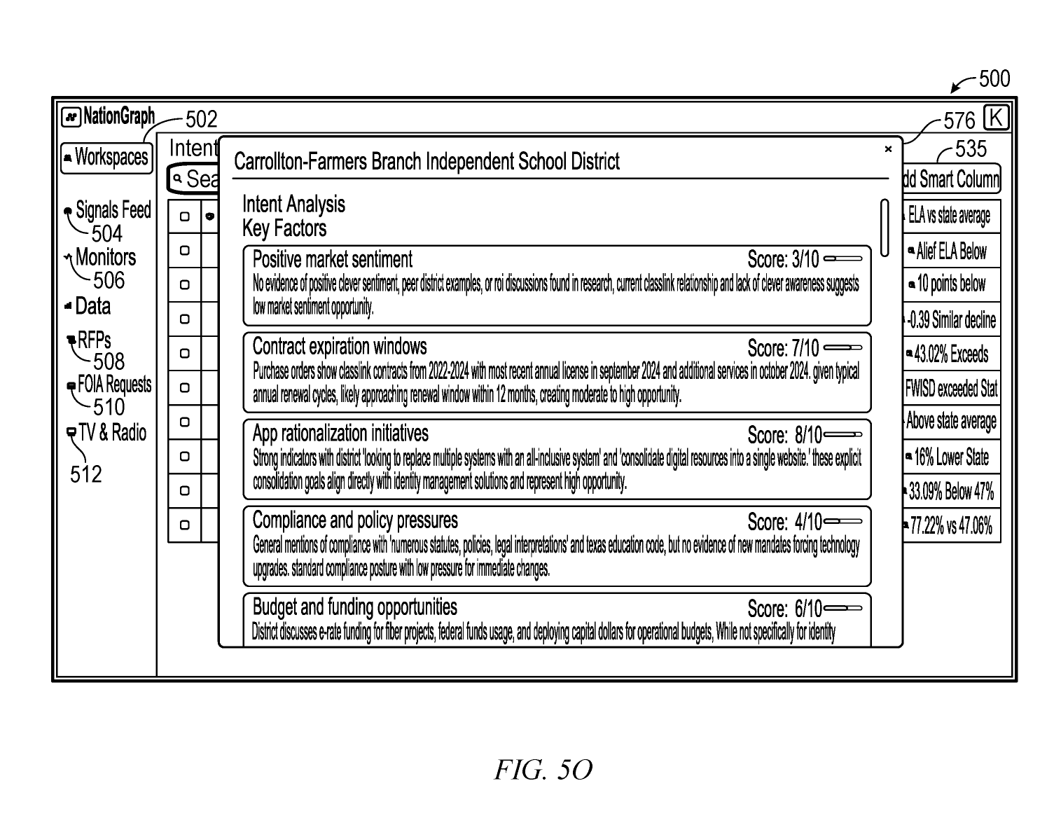

FIG. 5A depicts an example interface 500 that the government data analysis system 202 (for example, the user interface module 310) may provide for display to a user. The interface 500 has a menu region including a workspaces button 502, a signals feed button 504, a monitors button 506, an RFPs button 508, a FOIA requests button 510, and a TV and radio button 512. The interface 500 displays workspaces that the user has created, such as a workspace 514a and a workspace 514b. The user may request that the government data analysis system 202 generate a workspace by selecting the create workspace button 516.

Upon the user selecting the create workspace button 516, the government data analysis system 202 (for example, the user interface module 310) may display a window 518, as depicted in FIG. 5B, that includes options for the workspace. The user may select a blank workspace option 520, a contacts workspace option 522, or a signals workspace option 524. After selecting one of the options, the government data analysis system 202 (for example, the user interface module 310) may display a window 525 that allows the user to select government institutions, as depicted in FIG. 5C. The user may search for government institutions by filters, codes, or names using the option group 526 or the search field 528. Examples of filters include institution type (for example, K-12 school districts or state agencies), location (for example, by including or excluding state, county, or city), population size (for example, the number of people in a county, the number of students in a K-12 school district, the number of police officers in a police agency), or by keywords in a purchase order. The user may preview the government institutions by selecting the preview institutions button 532, which causes the window 525 to display a list 530 of government institutions along with profile data for the government institutions (institution type, state, county, city, population, etc.) The user may request that the government data analysis system 202 generate the workspace by selecting the create new workspace button 534.

Returning to FIG. 3, at step 454 the government data analysis system 202 (for example, the workspace module 312) may generate the workspace. At step 456 the government data analysis system 202 (for example, the user interface module 310) may provide the workspace for display. The workspace may include the government institutions that the user selected as well as profile data of the government institutions. FIG. 5D depicts the interface 500 showing a workspace 536. The workspace 536 includes a list of the government institutions organized in a table 538. The table 538 includes columns for a name of each government institution and profile data (state, county, city, etc.) for each government institution. The workspace 536 includes an actions button 537 that allows the user to request that the government data analysis system 202 perform certain functions, such as submit FOIA requests or export data about government institutions. The workspace 536 also includes an add smart column button 535. The user may select the add smart column button 535 to add smart columns to the table 538.

As described in more detail herein, the smart columns may include the results of different analyses, insights, or searches of data for government institutions. Additionally or alternatively, the smart columns may include data that the user may utilize to take actions regarding the government institutions, such as emailing or calling individuals associated with the government institutions. The government data analysis system 202 is able to generate the results or data in the smart columns by having obtained the data for the government institutions (for example, by web crawlers or by FOIA requests) and processing, classifying, and storing the data.

FIG. 5E depicts the interface 500 after the user has selected the add smart column button 535. The interface 500 displays a window 540 that includes different smart columns that the user may add to the table 538 of the workspace 536. The window 540 includes three smart column types grouped under a Communication Tools heading: 1) a generate email smart column 541 for requesting that the government data analysis system 202 generate custom emails using the workspace; 2) a find contacts smart column 542 for requesting that the government data analysis system 202 identify individuals associated with the government institutions in the workspace 536; and 3) a call script smart column 543 for requesting that the government data analysis system 202 generate a call script using the workspace.

The window 540 also includes four smart column types grouped under an AI & Analytics heading: 1) a NationGraph AI search smart column 544 for requesting that the government data analysis system 202 perform an artificial intelligence search of government data; 2) an intent smart column 545 for requesting that the government data analysis system 202 generate an intent score for the government institutions; 3) a Google search smart column 546 for requesting that the government data analysis system 202 perform a Google search for relevant information; and 4) a workspace summary smart column 547 for requesting that the government data analysis system 202 generate a summary of the signals and insights of the workspace.

The window 540 also includes four smart column types grouped under an External Intelligence heading: 1) a news smart column 548 for requesting that the government data analysis system 202 search news or other information corpuses; 2) an RFP smart column 549 for requesting that the government data analysis system 202 identify RFPs; and 3) a grants smart column 550 for requesting that the government data analysis system 202 search for funding opportunities and competitive intelligence.

The window 540 also includes three smart column types grouped under a Governance & Planning heading: 1) a strategic plans smart column 551 for requesting that the government data analysis system 202 identify long-term objectives, initiatives, or performance metrics; 2) a legislation smart column 552 for requesting that the government data analysis system 202 identify laws, rules, or statutory frameworks that may relate to the government institutions; and 3) a procurement guidelines smart column 553 for requesting that the government data analysis system 202 identify policies for acquisition, vendor engagement, and compliance.

The window 540 also includes three smart column types grouped under an Operational Records heading: 1) a meeting minutes smart column 554 for requesting that the government data analysis system 202 identify formal records of discussions, decisions, and action items.; 2) a purchase orders smart column 555 for requesting that the government data analysis system 202 identify purchase orders that may include transaction-level documentation of goods or services procured; and 3) an annual budgets smart column 556 for requesting that the government data analysis system 202 identify budgets or other documents that may include fiscal plans outlining revenues, expenditures, and allocations.

Returning to FIG. 3, at step 458 the government data analysis system 202 (for example, the user interface module 310) may receive a request to add data for the government institutions to the workspace. For example, the user may select the add smart column button 535 to add a smart column to the workspace 536. The request may include a prompt provided by the user.

At step 460, the government data analysis system 202 (for example, the retrieval module 314) may generate, based on the request, a search vector. For example, the government data analysis system 202 may generate a search vector based on the prompt. At step 462 the government data analysis system 202 (for example, the retrieval module 314) may identify, based on the search vector, stored vectors. For example, the government data analysis system 202 may search the vector database for stored vectors that are similar to the search vector. The government data analysis system 202 may filter the vector database based on the smart column to only search for vectors that represent data with the classification corresponding to the smart column. For example, if the user selects the annual budgets smart column 556, the government data analysis system 202 may filter the vector database to only search for vectors that represent data with the budgets classification.

At step 464 the government data analysis system 202 (for example, the retrieval module 314) may identify, based on the vectors that the government data analysis system 202 identified as similar to the search vector, one or more data segments of the stored data segments. For example, the government data analysis system 202 may identify the data segments that are stored in a text database that are represented by the vectors similar to the search vector. The government data analysis system 202 may then retrieve the identified data segments from the text database.

At step 466 the government data analysis system 202 (for example, the artificial intelligence module 326) may generate, based on the request, one or more inputs for one or more artificial intelligence models of one or more artificial intelligence systems 206. For example, the government data analysis system 202 may generate an input for an artificial intelligence model that is similar to the following: “You are an assistant. Use the context below to answer this question:” and include a prompt, such as a user-provided prompt, along with one or more data segments that the government data analysis system 202 retrieved as the context.

At step 468 the government data analysis system 202 (for example, the artificial intelligence module 326) may provide the one or more inputs and the one or more data segments to the one or more artificial intelligence models of the one or more artificial intelligence systems 206. At step 470 the government data analysis system 202 (for example, the artificial intelligence module 326) may receive one or more responses from the one or more artificial intelligence models. At step 472 the government data analysis system 202 (for example, the artificial intelligence module 326) may generate, based on the one or more responses, the data for the one or more government institutions to be added to the workspace. At step 474 the government data analysis system 202 (for example, the artificial intelligence module 326) may add the data for the one or more government institutions to the workspace.

Variations of or additional steps for the method 400, the method 450, or other methods or processes described herein are possible. For example, the government data analysis system 202 may, for each government institution, determine a point of contact (for example, an email address, an Application Programming Interface (API) call, a telephone number, or a URL) that may be utilized to make a FOIA request. For each government entity, the government data analysis system 202 may determine whether a human-assisted records request submission should be made or whether an automated records request submission should be made. For human-assisted records request submission, the government data analysis system 202 may provide a human with the appropriate data (for example, a telephone number, an email address, or a hyperlink) and provide the human with a user interface that the human may utilize to provide the government data analysis system 202 with the data received from the government entity. For an automated records request submission, the government data analysis system 202 may send the records request to a system of the government entity. In either case, the government data analysis system 202 may receive data of the government entity responsive to the request submissions and store the data.

The government data analysis system 202 may perform human-assisted records request submissions or automated records request submissions periodically or on an on-demand basis. For example, at a certain point in time, the government data analysis system 202 may perform the requests submissions to obtain data for the previous several years. Then, six months later, the government data analysis system 202 may perform the requests submissions to obtain data for the previous six months. In some embodiments, the government data analysis system 202 weights more recent government entity data more heavily than older government entity data.

One example of data that may be added to the workspace 536 is contact information. FIG. 5F depicts the interface 500 if the user has selected the find contacts smart column 542. The interface 500 displays a window 560 that includes a search prompt field. The user may provide a search prompt 561 that the government data analysis system 202 may provide to an artificial intelligence system 206 to identify contacts in the data for the government institution. FIG. 5G depicts the interface 500 displaying a window 562 that includes the search prompt 561 as well as several items of contact information, such as contact information 563a, contact information 563b, and contact information 563c. Each item of contact information may include an indication as to whether the individual is a direct match or a potential match based on the search prompt 561.

Another example of data that may be added to the workspace 536 is results of an analysis performed by an artificial intelligence model. For example, the user may select the NationGraph AI search smart column 544 of FIG. 5E and provide a prompt that the government data analysis system 202 may provide to an artificial intelligence system 206. FIG. 5H depicts the interface 500 displaying a window 564 that displays the prompt provided to the government data analysis system 202, shown as the prompt 565. The artificial intelligence system 206 may receive the prompt and utilize certain data segments as context to generate a response to the prompt for each government institution. For example, the government data analysis system 202 may generate a search vector based on the prompt, search the vector store using the search vector, and identify vectors similar to the search vector. The government data analysis system 202 may then utilize the data segments represented by the identified vectors as the context for the artificial intelligence system 206. The government data analysis system 202 may filter the vector store by classification. For the example given relating to procurement issues at the school district, the government data analysis system 202 may filter the vector store by meeting minutes or board packets or strategic plans classifications, so as to only identify vectors with those classifications. The window 564 of FIG. 5H also displays the response, shown as response 566, for one government institution that the artificial intelligence system 206 generated. The artificial intelligence system 206 may generate a response for each government institution in the workspace 536.

A user may also add data to the workspace 536 that includes the results of a news search. For example, the user may select the news smart column 548 of FIG. 5E and provide a prompt that the government data analysis system 202 may provide to an artificial intelligence system 206. The artificial intelligence system 206 may receive the prompt and utilize certain data segments as context to generate a response to the prompt for each government institution. For the example given for a news smart column, the government data analysis system 202 may filter the vector store by a news classification, so as to only identify vectors with the news classification. Additionally or alternatively, the government data analysis system 202 may receive news data for government institutions and store the news data in a separate corpus that the government data analysis system 202 utilizes to generate responses to requests to add data using the news smart column 548. FIG. 5I depicts the interface 500 displaying a window 567 that displays the prompt provided to the government data analysis system 202, shown as the prompt 568. The window 567 also displays the response, shown as response 569, for one government institution that the artificial intelligence system 206 generated. The artificial intelligence system 206 may generate a response for each government institution in the workspace 536.

Yet another example of data that may be added to the workspace is a generated email that a user may utilize to email individuals associated with government institutions. For example, the user may select the generate email smart column 541 of FIG. 5E. In response, the interface 500 may display a window 570 that the user may utilize to customize emails that an artificial intelligence system 206 may generate for the government institutions, as depicted in FIG. 5J. The user may specify a tone of the emails, provide a prompt for the artificial intelligence system 206 to utilize in generating the emails, provide a format of the emails, and specify columns of the workspace 536 (including profile data columns and smart columns) to be utilized by the artificial intelligence system 206 to personalize the emails. The user may also select a government institution to see a preview of a generated email and request that the government data analysis system 202 (for example, the campaign module 318) generate the emails. The government data analysis system 202 may utilize the selections or prompts that the user provided in the window 570 and generate inputs to the artificial intelligence system 206 and provide the inputs to the artificial intelligence system 206. The artificial intelligence system 206 may generate the emails for the government institutions based on the inputs. FIG. 5K displays the interface 500 displaying a window 571 that includes a generated email for a government institution. The window 571 displays a subject and a body for the generated email. The user may copy the subject and the body and utilize the copied subject and body in the user’s email software to send an email to individuals associated with the government institutions. In some embodiments, the government data analysis system 202 may allow the user to export emails to an email marketing tool or other software for sending emails.

Another example of data that may be added to the workspace 536 relates to purchase orders. For example, the user may select the purchase orders smart column 555 of FIG. 5E and provide one or more keywords or search terms to be utilized to search purchase orders. The artificial intelligence system 206 may receive the keywords or search terms and utilize data segments that are classified as purchase orders as context to generate a response to the prompt for each government institution. For the example given for the purchase orders smart column, the government data analysis system 202 may filter the vector store by a purchase orders classification, so as to only identify vectors with the purchase orders classification. The government data analysis system 202 may then provide the data segments that are represented by the identified vectors as context to the artificial intelligence system 206 along with a prompt, such as “find purchase orders for software.” FIG. 5L depicts the interface 500 displaying a window 572 that displays a response for a purchase orders analysis to identify purchase orders relating to software that the artificial intelligence system 206 generated for one government institution. The artificial intelligence system 206 may generate a response for a purchase orders analysis for each government institution in the workspace 536. The window 572 displays a list of purchase orders, along with a name of the vendor, the total amount of the purchase order, and the number of items in the purchase order. The user may select a purchase order to see more information about the purchase order.

Other examples of data that may be added to the workspace 536 are call scripts (using the call script smart column 543 of FIG. 5E), Google searches (using the google search smart column 546 of FIG. 5E), grants (using the grants smart column 550 of FIG. 5E), strategic plans (using the strategic plans smart column 551 of FIG. 5E), legislation (using the legislation smart column 552 of FIG. 5E), procurement guidelines (using the procurement guidelines smart column 553 of FIG. 5E), meeting minutes (using the meeting minutes smart column 554 of FIG. 5E), or budgets (using the annual budgets smart column 556 of FIG. 5E). In each case, the user may provide a prompt to the government data analysis system 202. The government data analysis system 202 may utilize the smart column type to filter vectors based on the classification corresponding to the smart column type and identify data segments represented by the filtered vectors. The government data analysis system 202 may then provide the identified data segments along with the prompt to an artificial intelligence system 206 for each government institution in the workspace 536. The artificial intelligence system 206 may generate a response for each government institution and provide the responses to the government data analysis system 202, which may then make the responses available in the workspace 536.

A user may also add data to the workspace 536 that includes a summary of signals and insights from the workspace 536. The user may select the workspace summary smart column 547, provide a prompt, and specify columns of the workspace 536 (including profile data columns and smart columns) to be utilized by the artificial intelligence system 206 to personalize the workspace summary. The government data analysis system 202 may utilize the selections or prompts that the user provided, generate inputs to the artificial intelligence system 206, and provide the inputs to the artificial intelligence system 206. The artificial intelligence system 206 may generate the workplace summaries for the government institutions based on the inputs and provide the workplace summaries to the government data analysis system 202, which may then make the workplace summaries available in the workspace 536.

As described herein, the government data analysis system 202 may utilize FOIA requests to obtain data for government institutions, such as data that is not available via the government data systems 204. The government data analysis system 202 may allow users to utilize the FOIA request functionality to obtain data for government institutions. A user may select one or more government institutions in the workspace 536 and select the actions button 537 to select one of several actions, such as to request FOIAs for the selected government institutions, to delete the selected government institutions, or to export the workspace, purchase orders, or contact information for the selected government institutions. If the user selects to request FOIAs, then the interface 500 may display a window 573 which allows the user to specify the information for which he or she is searching, as depicted in FIG. 5M. For example, the user may specify that he or she would like to obtain meeting minutes, budgets, or RFPs. The user may submit the FOIA request, and the government data analysis system 202 may receive the FOIA request. In some embodiments, the government data analysis system 202 may submit the FOIA request for the selected government institutions. In some embodiments, the government data analysis system 202 may provide the FOIA request along with a prompt to an artificial intelligence system 206 to request that the artificial intelligence system 206 modify the FOIA request. The artificial intelligence system 206 may respond to the government data analysis system 202 with a modified FOIA request. The government data analysis system 202 may then submit the modified FOIA request for the selected government institutions.

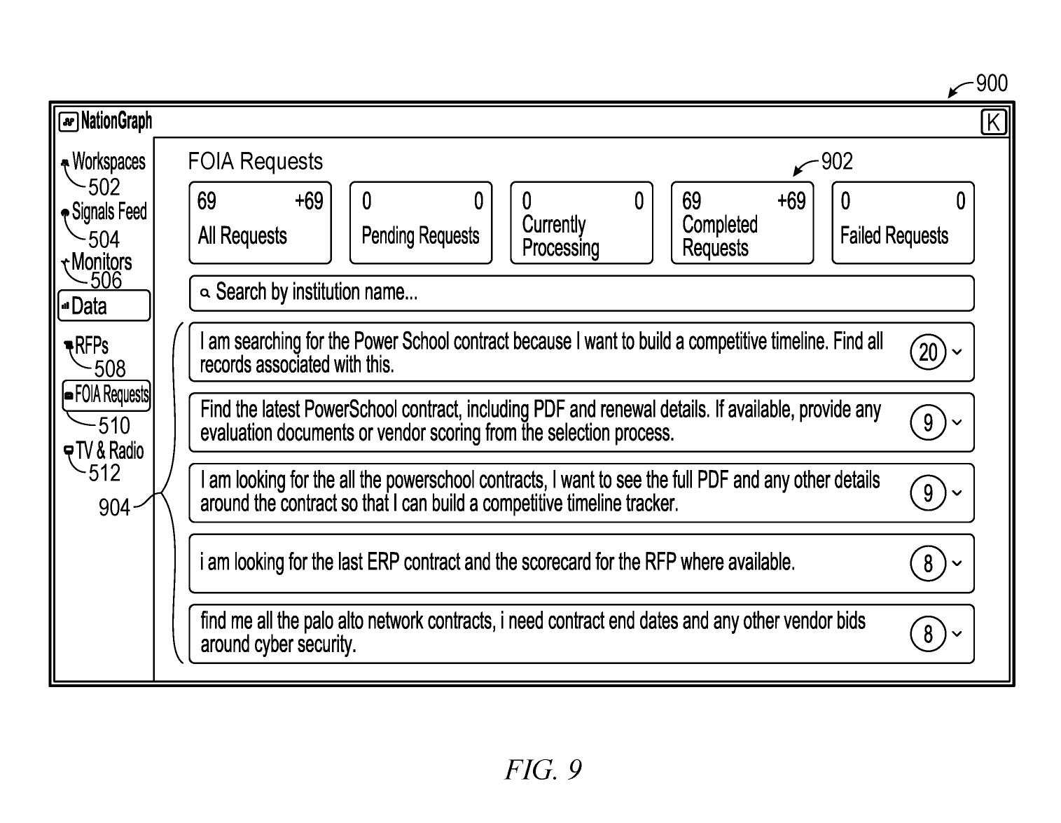

FIG. 9 depicts an example interface 900 for displaying FOIA requests that may be provided by the government data analysis system 202 according to some embodiments. The user may request that the government data analysis system 202 (for example, the user interface module 310) display the interface 900 by selecting the FOIA requests button 510. The interface 900 includes a region 902 displaying a total number of FOIA requests made by the user, a number of pending FOIA requests, a number of FOIA that are currently processing, a number of completed FOIA requests, and a number of failed FOIA requests. The interface 900 also includes a list 904 of FOIA requests that the user has made. Each FOIA request in the list 904 includes some or all of the body of the FOIA request that the user made and a number of government institutions to which the FOIA request was made or a number of response to the FOIA request. The user may select a FOIA request in the list 904 to view more details about the FOIA request.

Another example of data that may be added to the workspace 536 relates to an intent score. The user may select the intent smart column 545 of FIG. 5E to add an intent score to the workspace 536. The intent score may measure how relevant retrieved signals (from smart columns) are to a user’s queries or prompts generated by the government data analysis system 202. In some embodiments, the government data analysis system 202 may determine the intent score based on one or more of the following factors: 1) semantic similarity between the user prompt and the embeddings of the retrieved data segments in the smart columns; 2) classification match confidence (for example, how certain the government data analysis system 202 is that a data segment belongs to a particular smart column); or 3) recency and context alignment, when applicable (for example, a recent budget update might carry higher intent weight than a historical one). The government data analysis system 202 may utilize one or more of these factors to generate an intent score that ranks the relevance of each signal to the workspace 536.

FIG. 5N depict the interface 500 displaying a workspace that includes an intent score for each of several government institutions, shown in the intent column 575. A user may find the intent score useful because government institutions with higher intent scores may be more relevant to the purpose(s) for which the user is utilizing the workspace (for example, to search for government institutions that have just published RFPs, to identify government institutions that have technology contracts that are expiring soon, or to find the contact information of decision-makers in government institutions for certain functions). The user may select an intent score in the intent column 575 to see one or more key factors that the government data analysis system 202 has utilized to determine the intent score. FIG. 5O depicts the interface 500 displaying a window 576 that displays certain key factors behind an intent score, as well as the score for each factor. The key factors include 1) positive market sentiment; 2) contract expiration windows; 3) app rationalization initiatives; 4) compliance and policy pressures; and 5) budget and funding opportunities. The government data analysis system 202 may weight each factor equally to determine the intent score or may apply varying weights to each factor to determine the intent score.

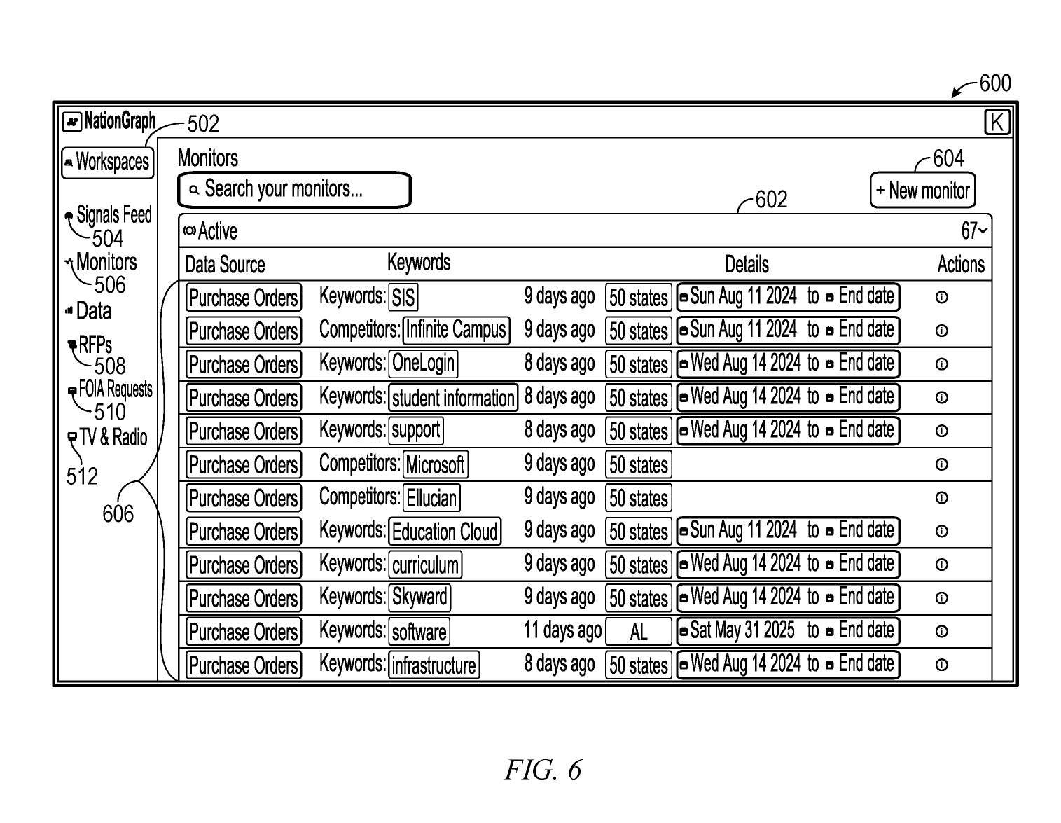

The government data analysis system 202 (for example, the monitors module 316) also allows a user to set up monitors to monitor data for government institutions that may be of interest to the user. For example, a user may work for a company that sells products that are complementary to products of a company that has just won a contract with a government institution. The user may utilize the government data analysis system 202 to monitor information that is relevant to the contract, the products of the other company, or actions of the government institution in implementing the products of the other company. A user may view existing monitors or set up new monitors by selecting the monitors button 506. FIG. 6 depicts an example interface 600 for providing monitors that may be provided by the government data analysis system according to some embodiments. The interface 600 includes a region 602 displaying a list 606 of monitors that the user has set up. Each monitor may have a data source, keywords, a time when the monitor was set up, a location (for example, one or more states) of the monitor, and the time period for which the monitor is active. The interface 600 also displays a new monitor button 604 that the user may select to set up a new monitor.

If the user selects the new monitor button 604, the government data analysis system 202 may display a window (not shown in FIG. 6) that allows the user to specify details of the monitor. The details may include the sources where the government data analysis system 202 (for example, TV and radio, purchase orders, RFPs, the data segments database, or a web search), keywords or a search query, a time period to search for, locations to search (for example, which U.S. states), and how often to check for updates (for example, daily, weekly, monthly). After the user has set up a monitor, the government data analysis system 202 may monitor the selected source using the keywords or the search query and the other details that the user provided.

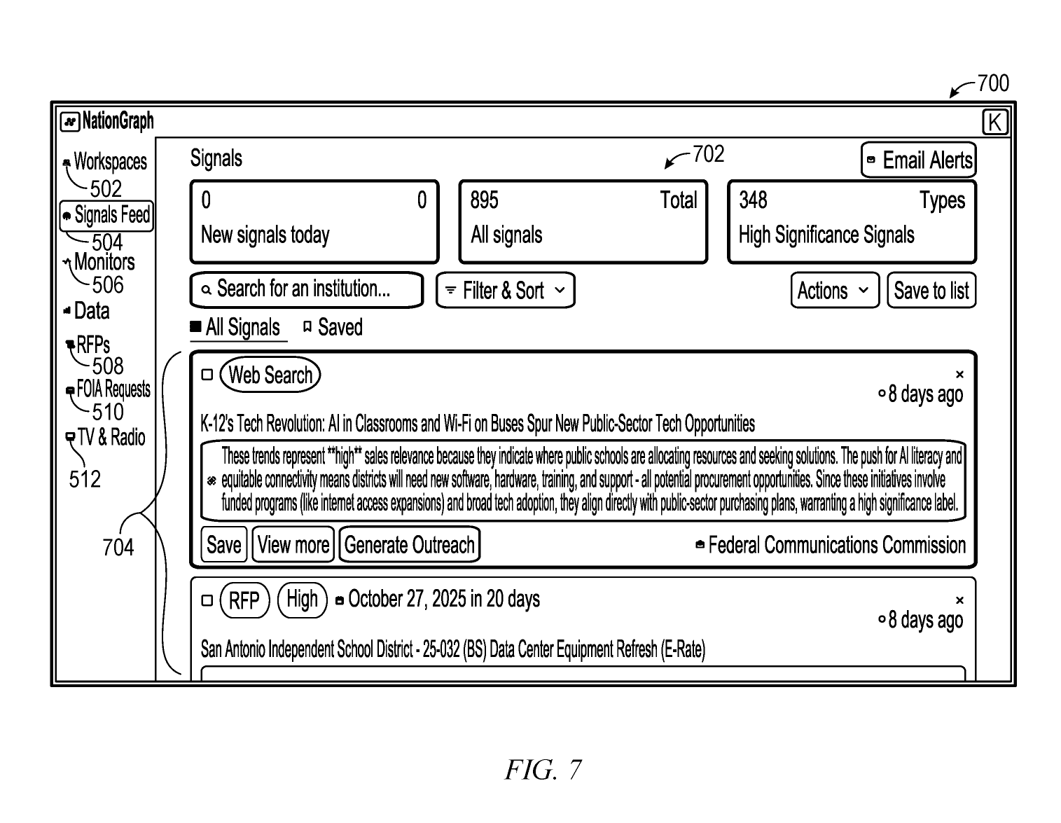

If the government data analysis system 202 finds information that is a match for the details that the user has specified, then the government data analysis system 202 (for example, the signals module 324) may provide a signal to the user. A user may view signals by selecting the signals feed button 504. FIG. 7 depicts an example interface 700 for providing signals that may be provided by the government data analysis system 202 in some embodiments. The interface 700 includes a region 702 displaying a number of new signals that day, a total number of signals, and a number of high significance signals. The interface 700 also includes a list 704 of signals. Each signal may include a source of the signal (for example, web search, RFP, purchase order, etc.) and details of the signal, such as why the information is relevant to the monitor the user set up. The government data analysis system 202 may determine that certain signals are of high significance based on how relevant the information is to the monitor. Each signal may include buttons for actions that the user may take with respect to the signal, such as to save the signal, to view more about the information for the signal, or to generate outreach (for example, an email or a call script) to an individual associated with the relevant government institution.

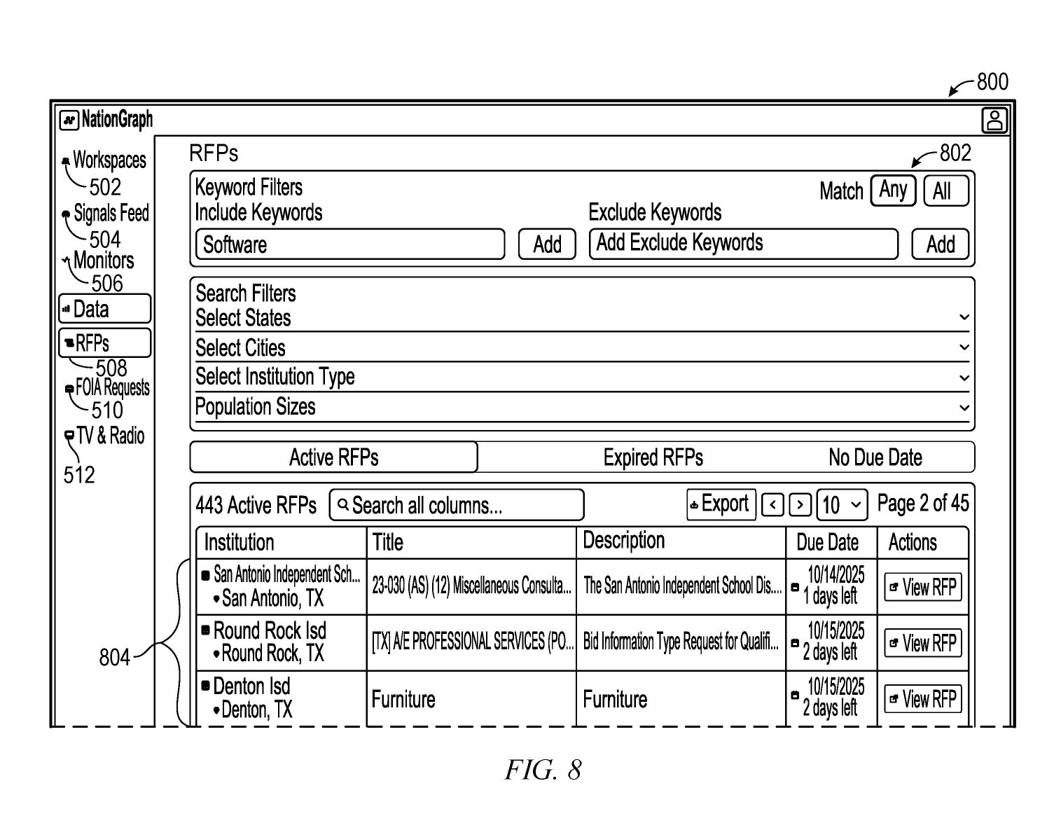

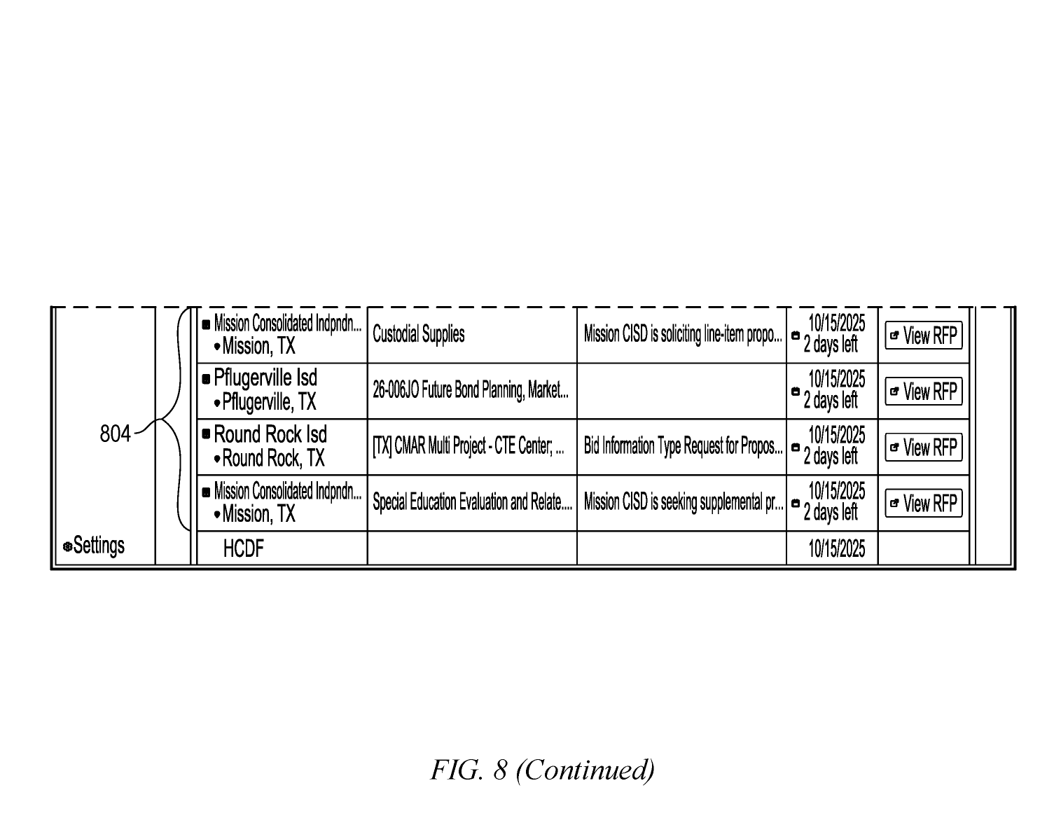

The government data analysis system 202 (for example, the RFP module 320) may also allow a user to view RFPs that the government data analysis system 202 has obtained, such as from the government data systems 204 or via FOIA requests. FIG. 8 depicts an example interface 800 for providing RFPs that may be provided by the government data analysis system 202 in some embodiments. The interface 800 includes a region 802 that allows the user to search for RFPs using keywords (include or exclude) and to filter by location, institution type, population size, or other profile data of government institutions. The user may view active RFPs, expired RFPs, or RFPs with no due date. The interface 800 also includes a list 804 of RFPs that match the user’s keywords. The user may also view an RFP by selecting the RFP.

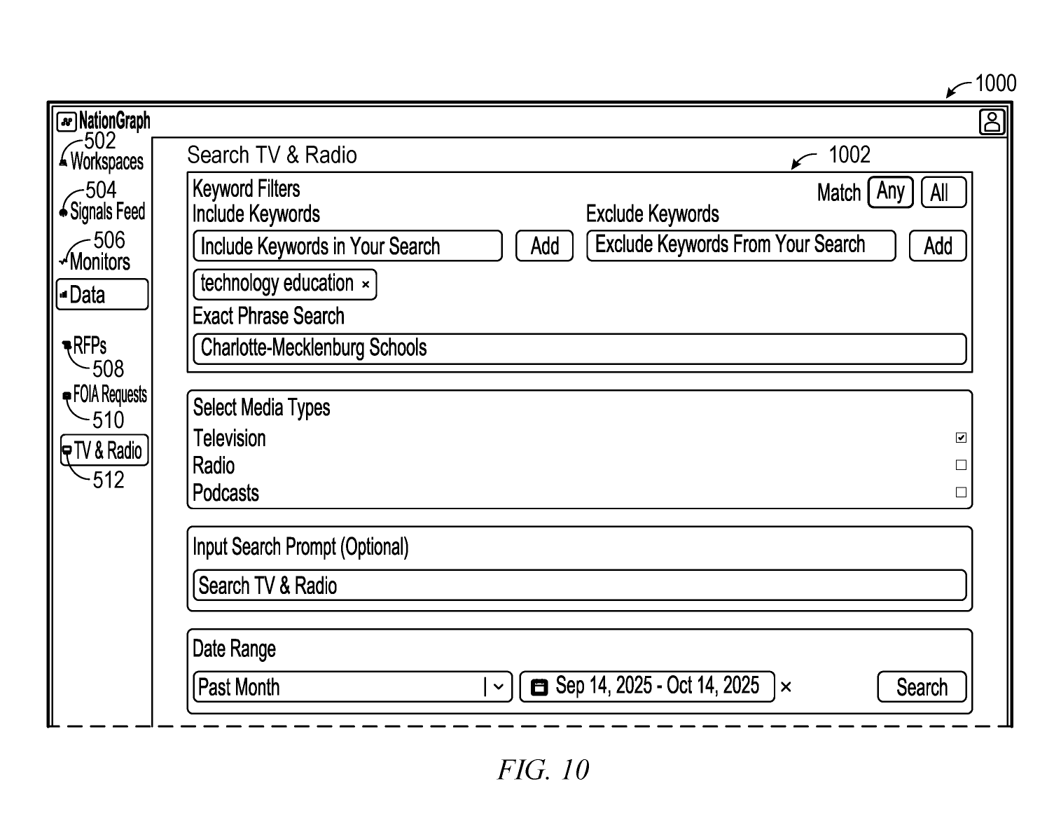

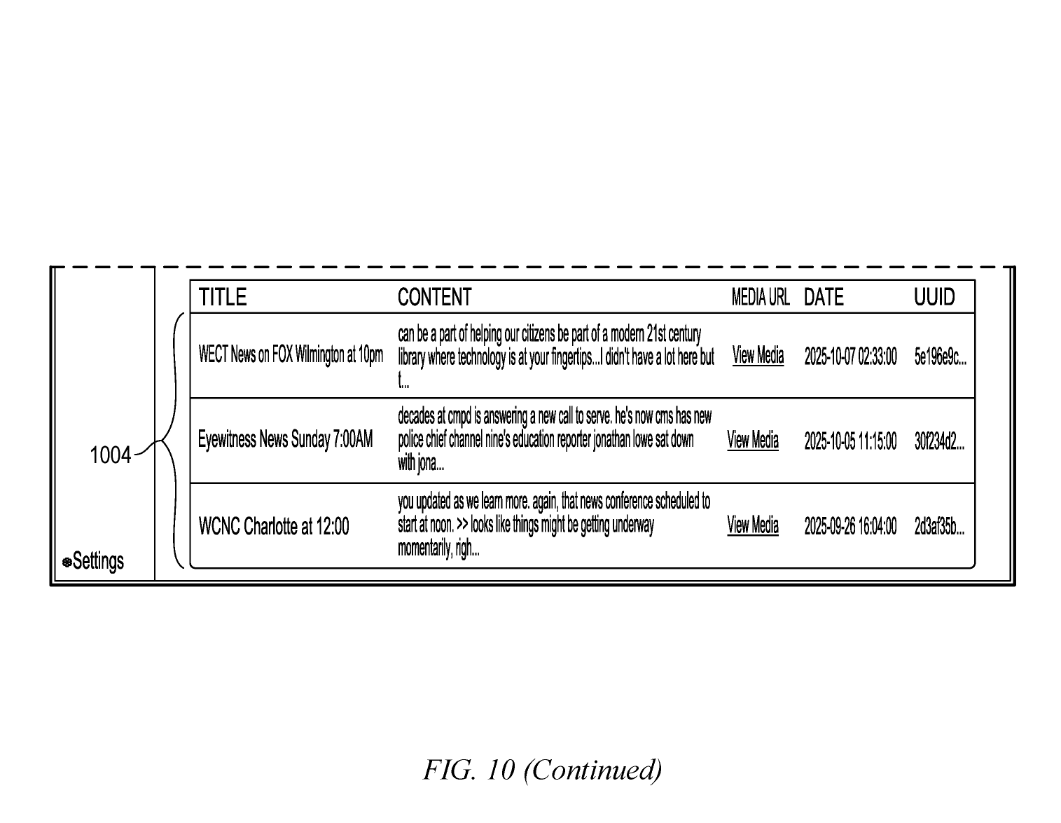

The government data analysis system 202 may also allow a user to search news, such as TV and radio news, for information relevant to the user. FIG. 10 depicts an example interface 1000 for providing news that may be provided by the government data analysis system 202 in some embodiments. The interface 1000 includes a region 1002 that allows the user to search for news using keywords (include or exclude) and to select news sources (for example, TV, radio, or podcasts). The user may also provide a prompt that may be utilized by the government data analysis system 202 in connection with making a request to an artificial intelligence system 206 to analyze news results. The interface 1000 also includes a list 1004 of news results that match the user’s keywords. The user may also view a news result by selecting the news result.

In some embodiments, instead of receiving prompts from users that are provided to an artificial intelligence system 206 to generate smart column results, the government data analysis system 202 allows users to build workspaces or to add data to workspaces without specifying prompts. In some embodiments, users of the government data analysis system 202 may have accounts with credits, and the government data analysis system 202 may debit user accounts a number of credits that is based upon usage of the government data analysis system 202.

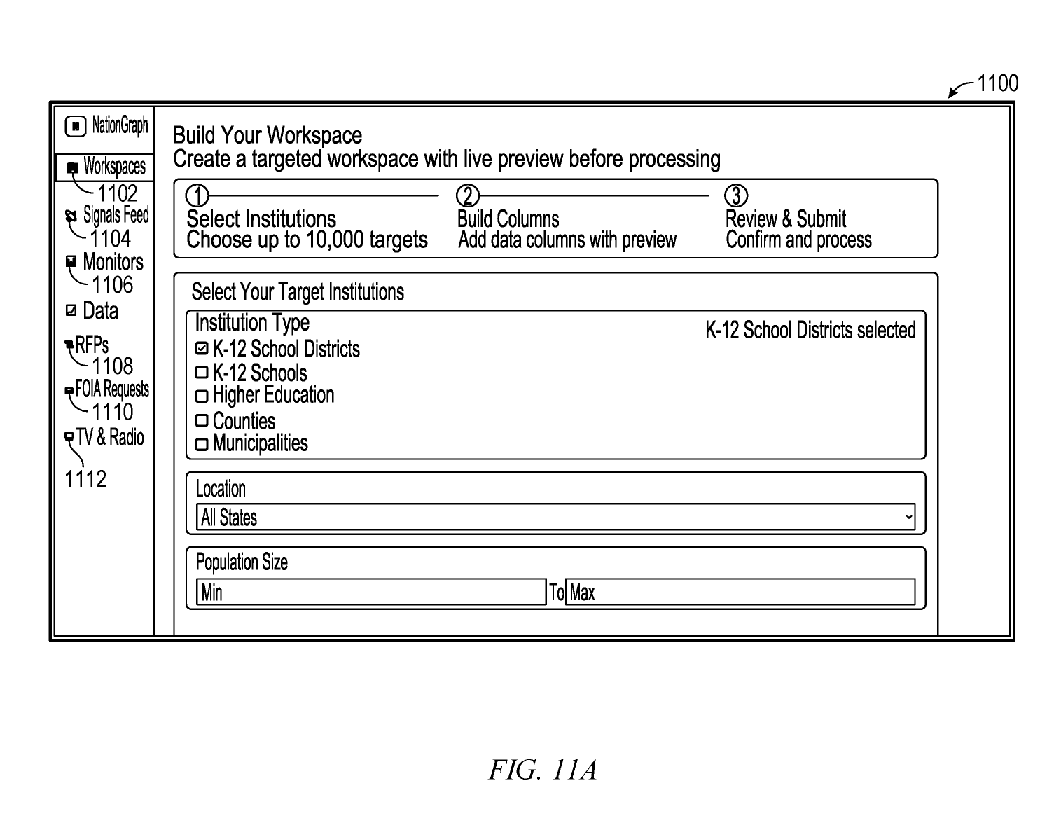

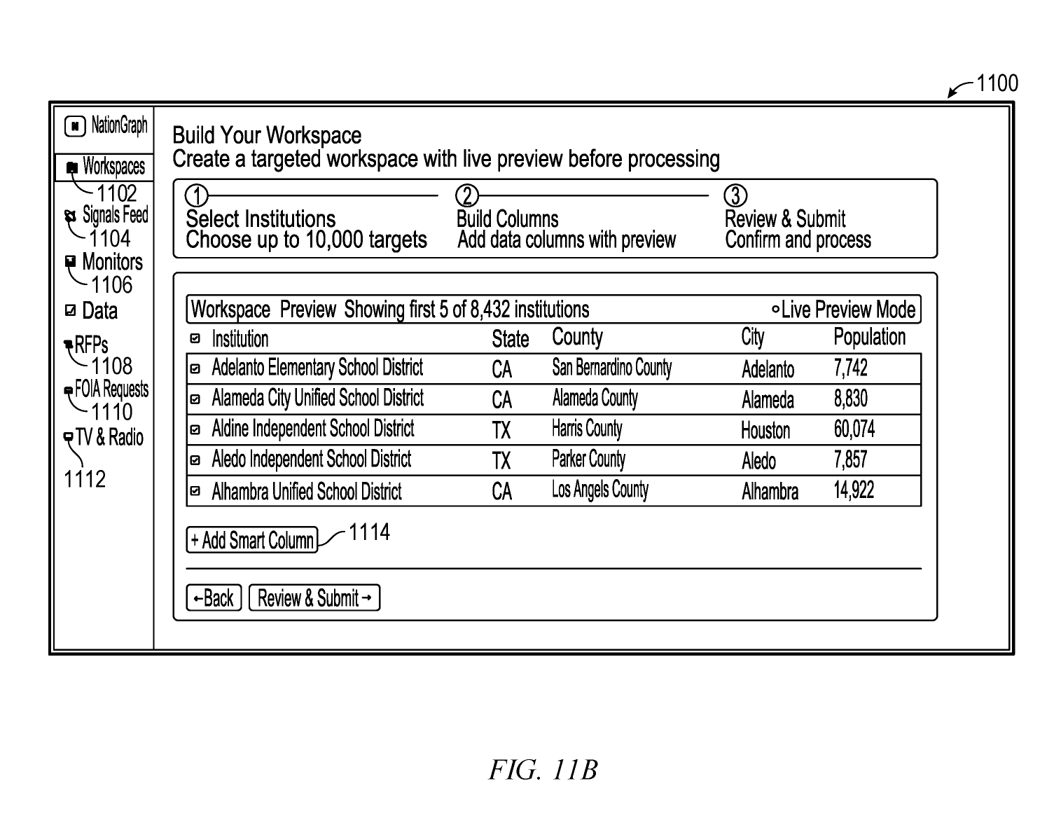

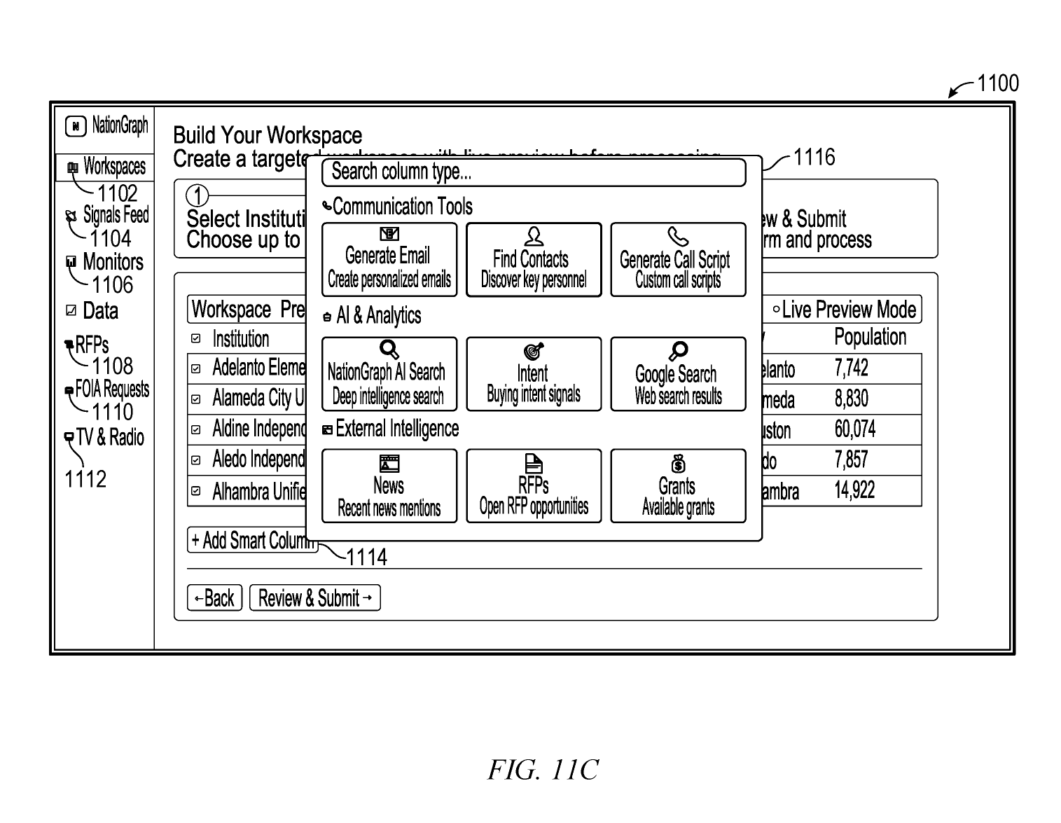

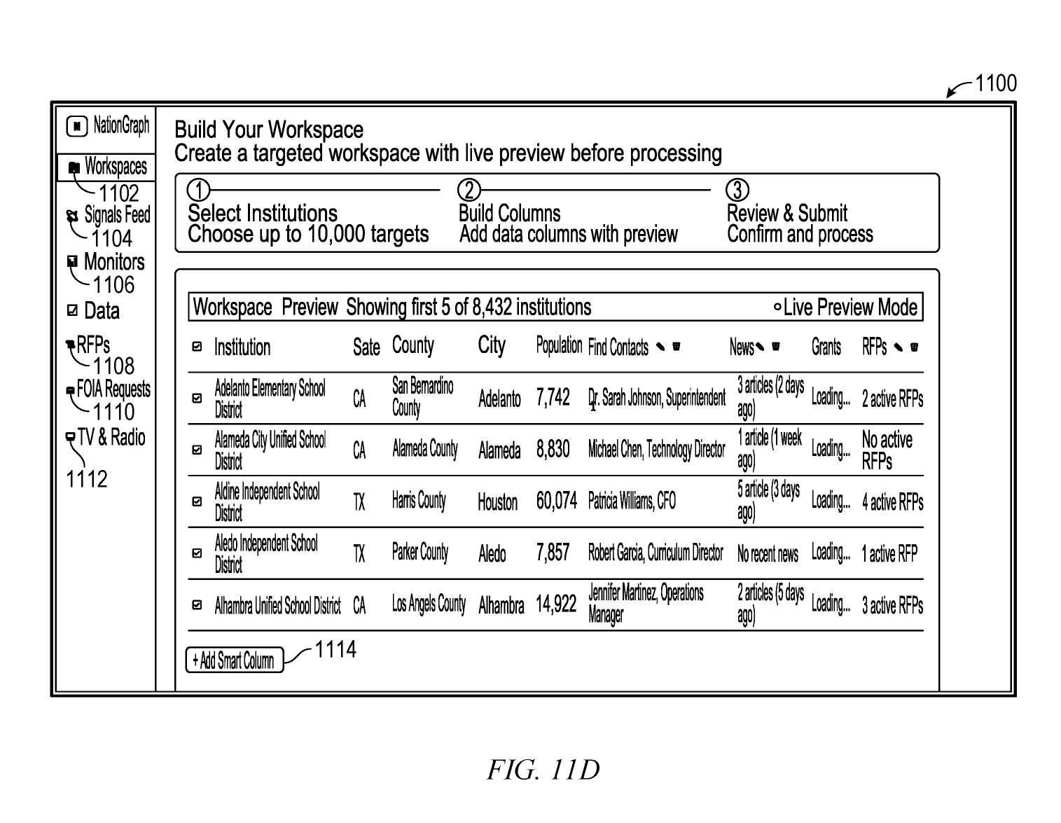

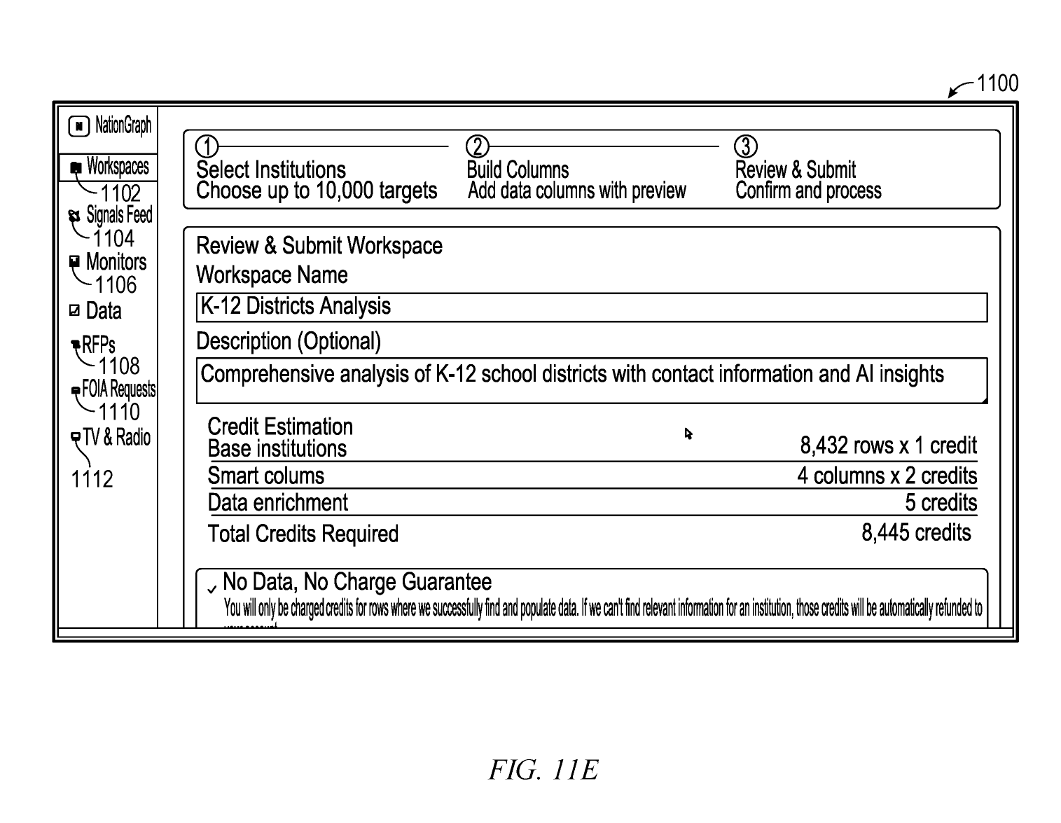

FIGS. 11A-11E depict an example interface 1100 for generating a workspace that may be provided by the government data analysis system 202 according to some embodiments. The interface 1100 has a menu region including a workspaces button 1102, a signals feed button 1104, a monitors button 1106, an RFPs button 1108, a FOIA requests button 1110, and a TV and radio button 1112.

As depicted in FIG. 11A, the user may select the target institutions in the interface 1100 (for example, K-12 School Districts, K-12 Schools, Higher Education, Counties, Municipalities, or other government institution types), the locations (for example, which U.S. states), and minimum and maximum population sizes. FIG. 11B depicts that the interface 1100 provides a preview of some of the government institutions selected by the user. The interface 1100 also includes an add smart column button 1114 that the user may select to add one or more smart columns to the workspace. FIG. 11C depicts a window 1116 after the user has selected the add smart column button 1114. The user may select one or more smart columns such as those described with reference to FIG. 5E. FIG. 11D depicts the interface 1100 after the user has selected the find contacts, news, grants, and RFPs smart columns. FIG. 11E depicts the interface 1100 after the user has selected a review and submit button (see FIGS. 11B and 11C). The interface 1100 displays a total number of credits that the government data analysis system 202 may charge the user account. In some embodiments, the government data analysis system 202 only charges the user account for rows in the workspace where the government data analysis system 202 is able to populate data for the government institutions.

The government data analysis system 202 may utilize other techniques to analyze data. For example, in addition to or as an alternative to utilizing retrieval-augmented generation (RAG) techniques, the government data analysis system 202 may generate an index for data of government institutions or news data and utilize keyword searches to find relevant information for users. As another example, the government data analysis system 202 may store results of common analyses that the government data analysis system 202 is requested to perform by users and provide the stored results to the users, instead of or in addition to re-running the analyses. As yet another example, the government data analysis system 202 may utilize Natural Language Processing (NLP) techniques such as named entity recognition, topic modeling, sentiment analysis, text mining techniques such as clustering, text classification, or keyword extraction. The platform may also utilize other artificial intelligence or machine learning approaches to analyze the data. Other techniques will be apparent.

The following are non-limiting examples of how the government data analysis system 202 may analyze the data and functionality. For example, the government data analysis system 202 may provide or facilitate advanced line-item analysis using LLMs by, for example: employing LLMs to analyze descriptions of each line-item purchase from FOIA data; extracting nuanced information, including implicit or explicit expiration dates of goods and services; predicting contract renewal timelines even when not directly stated; enabling companies to proactively identify upcoming selling opportunities; or assisting government agencies in managing renewals and ensuring operational continuity.

The government data analysis system 202 may provide or facilitate cross-institutional pricing landscape modeling by, for example: analyzing purchase data across different institutions for identical products, services, or SKU numbers; utilizing data normalization and entity resolution algorithms for consistency; aggregating pricing information to create a dynamic pricing landscape model (akin to a "Kelley Blue Book" for government procurement); providing real-time market valuations to vendors and government institutions; or offering actionable insights for fair pricing, informed negotiations, and budgeting decisions.

The government data analysis system 202 may provide or facilitate comprehensive vendor analytics by, for example: mapping and profiling all suppliers providing goods and services to specific government institutions; implementing network analysis and clustering algorithms to identify vendor relationships and market penetration; detecting areas of sole-source versus competitive supply; helping companies understand their competitive landscape; or aiding government agencies in supplier diversification and risk management.

The government data analysis system 202 may provide or facilitate a recommendation engine for sales opportunities by, for example: ingesting a variety of documents obtained via FOIA, including purchase orders, RFPs, RFP scorecards, and contract data; developing a recommendation engine that ranks sales opportunities for companies selling to the government; predicting factors like agency buying patterns, contract award likelihood, and optimal engagement timing; or providing a prioritized list of actionable opportunities for companies.

In addition to government data, the government data analysis system 202 may collect, stage, and analyze data from non-governmental sources and use such data in conjunction with government data. For example, the government data analysis system 202 may collect, stage, and analyze economic forecast data and utilize the economic forecast data to generate actionable insights. For example, the government data analysis system 202 may obtain data relating to Gross Domestic Product (GDP) growth forecasts or inflation forecasts. The government data analysis system 202 may utilize such data in conjunction with FOIA data on spend on certain products or services to forecast increased spend on the products or services by one or more government entities. Other uses of non-government data are possible.

Contractors may encounter difficulty in competing for government contracts due to a lack of necessary insights that are essential for running a successful sales organization. The government data analysis system 202 may extract actionable insights based on the data before or after normalization, and provide the actionable insights at the appropriate times to users of the government data analysis system 202. Examples of actionable insights that the government data analysis system 202 may provide include, without limitation, the following:

The government data analysis system 202 may identify expirations on purchases, such as those pertaining to a subscription or a renewable service. This may allow the government data analysis system 202 to determine when the product or service needs to be replaced, renewed, or renegotiated. The government data analysis system 202 may provide notifications to businesses that provide products or services that a government entity may purchase in the renewal or renegotiation of an existing contract or for the replacement of the existing products or services.

The government data analysis system 202 may identify differences in the prices different government entities pay for the same or similar products or services. This may allow the government data analysis system 202 to notify a business selling an existing product or service to one government entity at a particular price agency that the business could potentially sell the same or similar product or service at a higher price to another government entity.

Actionable insights that the government data analysis system 202 may provide may enable businesses to optimize their sales strategies when targeting public sector clients. By leveraging this comprehensive approach to public sector intelligence, the government data analysis system 202 may enhance the efficiency and effectiveness of B2G sales operations. The government data analysis system 202 may provide businesses with the strategic insights needed to make more informed decisions in the government contracting space.

The government data analysis system 202 may address a significant challenge in the government contracting sector, which is the difficulty of effectively navigating complex and opaque government procurement processes. Specific aspects of this challenge may include: identifying appropriate points of contact within government entities poses a substantial difficulty; understanding the diverse procurement processes employed by various government entities is inherently complex; or understanding contracts compliance processes for particular agencies may also be opaque, yet the agencies may want contractors to identify their compliance procedures during the bid process.

The government data analysis system 202 may assist businesses with understanding and navigating government procurement processes. The government data analysis system 202 may provide information as to relevant points of contact, RFP pricing thresholds, reporting and compliance requirements, or historical government purchasing decisions. Such information may improve the ability of businesses to win government contracts.

The government data analysis system 202 may generate insights that users of the government data analysis system 202 may utilize in government contracting. The following are examples of insights that the government data analysis system 202 may generate under a category of insights generated on top of historic spend: 1) Entity X spent $500000 on cloud services last year, with the contract expiring in 6 months. In 6 months, Entity X will need to find a new vendor or renew with the old one; 2) School District Y has been increasing its annual Information Technology (IT) infrastructure budget by 15% over the past three years. This is a good indicator that if a business sells IT infrastructure products School District Y will be a big buyer; 3) City Z recently completed year 1 of a 5 contract for network security solutions. This means City Z likely has no more to spend and that a business should not focus their efforts here.

The following are examples of insights that the government data analysis system 202 may generate under a category of future signals: 1) County A's budget document allocates $2 million for a new data analytics platform; 2) University B just hired a new Chief Technology Officer (CTO) with a background in Artificial Intelligence (AI) and Machine Learning (ML); 3) The state legislature approved a $50 million fund for modernizing government IT systems.

The following are examples of insights that the government data analysis system 202 may generate under a category of procurement processes: 1) Municipality C has a $100000 threshold for competitive bidding. This means that if a business can sell its products or services for under this amount the business does not have to go through a formal competition process. This is a key pricing insight; 2) School District D primarily uses cooperative purchasing agreements for technology acquisitions. The government data analysis system 202 can surface a list of coops most commonly used and who a business should partner with to get their sale to move quickly; 3) State E requires all IT purchases over $1 million to go through a formal RFP process.

The following are examples of insights that the government data analysis system 202 may generate under a category of combined insights: 1) City F's $3 million cybersecurity contract is expiring in 3 months, they have allocated $4 million in their new budget for cybersecurity, and their Chief Information Officer (CIO) recently attended a conference on zero-trust architecture; 2) County G's Customer Relationship Management (CRM) Opportunity: a) Past Purchase: County G invested $750000 in a CRM system two years ago on a 5-year contract. Strategic Focus; b) Their new strategic plan prioritizes improved citizen engagement; c) Timing: They are approaching their end-of-year purchase deadline; d) Procurement: They have a $300000 threshold for simplified acquisition procedures for additional service contracts related to their CRM; e) Opportunity: There's potential for an IT services consultant to provide additional support or enhancements to their existing CRM system; 3) University H's IT support contract is ending this year, they have posted job openings for cloud architects, and they frequently use the state's master service agreement for IT services; 4) School District I has been gradually increasing spending on ed-tech solutions, their superintendent recently announced a "digital-first" initiative, and they have a streamlined procurement process for purchases under $250000; 5) State J's legacy ERP system contract is expiring next year, they have earmarked $10 million for modernization in their budget, and they require vendors to be pre-qualified through their IT vendor pool and be StateRamp Certified; 6) City K's recent audit revealed outdated emergency communication systems, their new budget includes funding for public safety technology upgrades. For any past purchase they historically have purchased vendors through the General Services Administration.

It will be appreciated that the government data analysis system 202 may generate insights other than those described herein.

Although many examples described herein relate to government institutions in the SLED market, the government data analysis system 202 may assist businesses in contracting with other government entities, such as government entities responsible for defense or national security, health care, treasury or finance, retirement security, or agriculture. Moreover, the government data analysis system 202 generalizes well beyond government use cases. In broad terms, the government data analysis system 202 may: 1) orchestrate pipelines that ingest heterogeneous public or private feeds (documents, transaction logs, tickets, sensor data); 2) process, classify, and store representations of the data (for example, store vectors in a vector datastore to enable semantic retrieval and similarity search) and the data; and 3) materialize clean, analysis‑ready tables or views that power vertical applications built with LLMs. Because the semantic layer abstracts over file types and schemas, downstream apps can unify unstructured text with structured fields, apply retrieval‑augmented generation, and constrain outputs with filters, joins, and policies.

The same pattern may be deployed in regulated or unregulated environments, with controls such as record‑level provenance, audit logging, and policy‑based access to align with frameworks like HIPAA, PCI‑DSS, and GDPR without implying certification. In practice, the SLED‑focused analysis system illustrates the model: a natural language user interface backed by a vector‑indexed corpus and tabular materializations that provides an approach that readily transfers to any domain where teams need to ask complex, cross‑source questions against constantly changing data.

Across industries, the same capabilities unlock high‑value, defensible workflows. In financial services, ingestion of transactions, know your client (KYC) files, adverse media, and sanctions lists can populate a permission‑aware corpus; vector search plus rules on the tabular layer may surface look‑alike risk, uncover multi‑account fraud patterns, or accelerate investigations. In healthcare and life sciences, embeddings over clinical notes, registries, device logs, and literature can ground LLM copilots for care coordination, trial matching, and pharmacovigilance, while export‑controlled tables preserve lineage and access boundaries. Telecom operators can unify network topology, trouble tickets, and chat transcripts so agents or planners ask natural‑language questions about outage root causes or churn drivers and receive cite‑back answers linked to source artifacts. Energy and utilities can fuse SCADA summaries, work orders, and inspection text to prioritize maintenance and shorten outage restoration. Supply‑chain, logistics, and manufacturing teams can combine shipment events, supplier disclosures, quality reports, and ESG filings to anticipate delays, trace provenance, and generate compliant documentation on request. Insurers can triage claims by synthesizing adjuster notes, imagery captions, and historical loss tables; cybersecurity teams can ground incident response in tickets, playbooks, and identity/permission exports; and retail/e‑commerce can drive customer retention, attribution, and merchandising by blending product catalogs, reviews, and clickstreams. In each case, the promise is consistent: ingest any feed, encode for semantic retrieval, materialize reliable tables, and let LLM‑based applications answer questions, draft actions, and automate workflows, thereby extending the approach of the government data analysis system 202 well beyond the SLED or other government institution contexts.

FIG. 12 depicts a block diagram of an example digital device 1200 according to some embodiments. The digital device 1200 is shown in the form of a general-purpose computing device. The digital device 1200 includes at least one processor 1202, which may be or include one or more central processing units (CPUs) or one or more graphics processing units (GPUs), random access memory (RAM 1204), communication interface 1206, input/output device 1208, storage 1210, and a system bus 1212 that couples various system components including storage 1210 to the at least one processor 1202. A set (which may be a physical set or a logical set) of one or more of the digital device 1200 may be referred to as a computing system.

System bus 1212 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1200 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1202 is configured to execute executable instructions (for example, programs). In some embodiments, the at least one processor 1202 comprises circuitry or any processor capable of processing the executable instructions.

In some embodiments, RAM 1204 stores programs or data. In various embodiments, working data is stored within RAM 1204. The data within RAM 1204 may be cleared or ultimately transferred to storage 1210, such as prior to reset or powering down the digital device 1200.

In some embodiments, the digital device 1200 is coupled to a network via communication interface 1206. The digital device 1200 can communicate with one or more networks such as a local area network (LAN), a general wide area network (WAN), or a public network (for example, the Internet).

In some embodiments, input/output device 1208 is any device that inputs data (for example, mouse, keyboard, stylus, sensors, etc.) or outputs data (for example, speaker, display, virtual reality headset).

In some embodiments, storage 1210 can include computer system readable media in the form of non-volatile memory, such as read only memory (ROM), programmable read only memory (PROM), solid-state drives (SSD), flash memory, or cache memory. Storage 1210 may further include other removable/non-removable, volatile/non-volatile computer system storage media. By way of example only, storage 1210 can be provided for reading from and writing to a non-removable, non-volatile magnetic media. The storage 1210 may include a non-transitory computer-readable medium, or multiple non-transitory computer-readable media, which stores programs or applications for performing functions such as those described herein. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1212 by one or more data media interfaces. As will be further depicted and described below, storage 1210 may include at least one program product having a set (for example, at least one) of program modules that are configured to carry out the functions of embodiments of the technology. In some embodiments, RAM 1204 is found within storage 1210.

Programs/utilities, having a set (at least one) of program modules may be stored in storage 1210 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the technology as described herein.

It should be understood that although not shown, other hardware or software components could be used in conjunction with the digital device 1200. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a circuit, module or system. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present technology may be written in any combination of one or more programming languages, including an object-oriented programming language such as Java, Smalltalk, C++, Python, or the like and conventional procedural programming languages, such as the C programming language or similar programming languages. The computer program code may execute entirely on any of the systems described herein or on any combination of the systems described herein.

Aspects of the present technology may be described with reference to flowchart illustrations or block diagrams of methods, apparatus (systems) and computer program products according to embodiments of the technology. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While particular elements, embodiments and applications have been shown and described, it will be understood, of course, that the claims are not limited thereto since modifications may be made by those skilled in the art without departing from the spirit and scope of the present disclosure, particularly in light of the foregoing teachings. Such modifications are to be considered within the purview and scope of the claims appended hereto.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are only examples, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

Headings in this application may be provided for organization and may not necessarily be used to interpret or constrain the purview and scope of the claims appended hereto. Moreover, concepts or features of technologies described under a particular heading may be used in technologies described under other headings. Accordingly, technologies described under a particular heading are not limited to the concepts or features described under that particular heading.

It may be apparent that various modifications may be made, and other embodiments may be used without departing from the broader scope of the discussion herein. Therefore, these and other variations upon the example embodiments are intended to be covered by the disclosure herein.

1. A method comprising:
receiving multiple sets of data for multiple government institutions, a set of data for a government institution including profile data of the government institution and one or more of contact information of one or more individuals associated with the government institution, one or more meeting materials of the government institution, or one or more budgets of the government institution;
for each set of data of the multiple sets of data:
generating, based on the data in the set, multiple data segments;
generating, based on the multiple data segments, multiple vectors, a vector representing a data segment; and
storing the multiple data segments and the multiple vectors;
receiving a request to generate a workspace that includes one or more particular government institutions of the multiple government institutions;
generating the workspace, the workspace including the one or more particular government institutions and the profile data of the one or more particular government institutions;
providing the workspace for display;
receiving a request to add data for the one or more particular government institutions to the workspace;
generating, based on the request, a search vector;
identifying, based on the search vector, one or more particular vectors of the multiple vectors;
identifying, based on the one or more particular vectors, one or more particular data segments of the multiple data segments;
generating, based on the request, one or more inputs for one or more artificial intelligence models;
providing the one or more inputs and the one or more particular data segments to the one or more artificial intelligence models;
receiving one or more responses from the one or more artificial intelligence models;
generating, based on the one or more responses, the data for the one or more particular government institutions; and
adding the data for the one or more particular government institutions to the workspace.

2. The method of claim 1, further comprising:
receiving a request to monitor a corpus for information relevant to one or more keywords or search queries;
monitoring the corpus using the one or more keywords or search queries;
determining, based on the monitoring, that the corpus includes information relevant to the one or more keywords or search queries;
generating, based on the information relevant to the one or more keywords or search queries, one or more signals; and
providing the one or more signals for display.

3. The method of claim 1 wherein the data for the one or more particular government institutions includes contact information for one or more individuals associated with the one or more particular government institutions, and further comprising:
receiving a request to display or export the contact information for the one or more individuals; and
providing the contact information for the one or more individuals for display or export.

4. The method of claim 1 wherein receiving the multiple sets of data for the multiple government institutions includes:
receiving, for at least one government institution of the multiple government institutions, freedom of information act (FOIA) request information that is usable to generate a FOIA request for information of the at least one government institution;
generating, based on the FOIA request information, a FOIA request for the information of the at least one government institution;
submitting the FOIA request for the information of the at least one government institution; and
receiving, in response to the FOIA request, at least one set of information of the at least one government institution.

5. The method of claim 1, further comprising:
receiving a request to submit a FOIA request for information of at least one particular government institution of the one or more particular government institutions;
accessing FOIA request information that is usable to generate a FOIA request for information of the at least one particular government institution;
generating, based on the request and the FOIA request information, the FOIA request for the information of the at least one particular government institution;
submitting the FOIA request for the information of the at least one particular government institution;
receiving, in response to the FOIA request, the information of the at least one particular government institution; and
providing the information of the at least one particular government institution for display.

6. The method of claim 1 wherein receiving the multiple sets of data for the multiple government institutions includes obtaining, using multiple web crawlers, the multiple sets of data for the multiple government institutions from multiple government data systems.

7. The method of claim 1, further comprising:
receiving a request to add one or more intent scores for the one or more particular government institutions to the workspace;
generating, based on the request, one or more inputs to the one or more artificial intelligence models, the one or more inputs including one or more requests to generate the one or more intent scores;
receiving one or more responses from the one or more artificial intelligence models, the one or more responses including the one or more intent scores; and
adding the one or more intent scores for the one or more particular government institutions to the workspace.

8. The method of claim 1 wherein the request to add data to the workspace for the one or more particular government institutions includes a prompt, and generating, based on the request, the one or more inputs for the one or more artificial intelligence models includes generating, based on the prompt, the one or more inputs for the one or more artificial intelligence models.

9. The method of claim 1, further comprising:
receiving multiple requests for proposal for at least some of the multiple government institutions;
storing the multiple requests for proposal;
receiving a search request to search the multiple requests for proposal;
identifying, based on the search request, one or more particular requests for proposal of the multiple requests for proposal; and
providing the one or more particular requests for proposal for display.

10. The method of claim 1, further comprising:
receiving a request to add an email or a call script for the one or more particular government institutions to the workspace;
generating, based on the request, one or more inputs to the one or more artificial intelligence models, the one or more inputs including one or more requests to generate one or more emails or call scripts;
receiving one or more responses from the one or more artificial intelligence models, the one or more responses including the one or more emails or call scripts; and
adding the one or more emails or call scripts for the one or more particular government institutions to the workspace.

11. One or more non-transitory computer-readable media comprising executable instructions that when executed by one or more processors of a system cause the system to perform a method comprising:
receiving multiple sets of data for multiple government institutions, a set of data for a government institution including profile data of the government institution and one or more of contact information of one or more individuals associated with the government institution, one or more meeting materials of the government institution, or one or more budgets of the government institution;
for each set of data of the multiple sets of data:
generating, based on the data in the set, multiple data segments;
generating, based on the multiple data segments, multiple vectors, a vector representing a data segment; and
storing the multiple data segments and the multiple vectors;
receiving a request to generate a workspace that includes one or more particular government institutions of the multiple government institutions;
generating the workspace, the workspace including the one or more particular government institutions and the profile data of the one or more particular government institutions;
providing the workspace for display;
receiving a request to add data for the one or more particular government institutions to the workspace;
generating, based on the request, a search vector;
identifying, based on the search vector, one or more particular vectors of the multiple vectors;
identifying, based on the one or more particular vectors, one or more particular data segments of the multiple data segments;
generating, based on the request, one or more inputs for one or more artificial intelligence models;
providing the one or more inputs and the one or more particular data segments to the one or more artificial intelligence models;
receiving one or more responses from the one or more artificial intelligence models;
generating, based on the one or more responses, the data for the one or more particular government institutions; and
adding the data for the one or more particular government institutions to the workspace.

12. The one or more non-transitory computer-readable media of claim 11, the method further comprising:
receiving a request to monitor a corpus for information relevant to one or more keywords or search queries;
monitoring the corpus using the one or more keywords or search queries;
determining, based on the monitoring, that the corpus includes information relevant to the one or more keywords or search queries;
generating, based on the information relevant to the one or more keywords or search queries, one or more signals; and
providing the one or more signals for display.

13. The one or more non-transitory computer-readable media of claim 11 wherein the data for the one or more particular government institutions includes contact information for one or more individuals associated with the one or more particular government institutions, and the method further comprising:
receiving a request to display or export the contact information for the one or more individuals; and
providing the contact information for the one or more individuals for display or export.

14. The one or more non-transitory computer-readable media of claim 11 wherein receiving the multiple sets of data for the multiple government institutions includes:
receiving, for at least one government institution of the multiple government institutions, freedom of information act (FOIA) request information that is usable to generate a FOIA request for information of the at least one government institution;
generating, based on the FOIA request information, a FOIA request for the information of the at least one government institution;
submitting the FOIA request for the information of the at least one government institution; and
receiving, in response to the FOIA request, at least one set of information of the at least one government institution.

15. The one or more non-transitory computer-readable media of claim 11, the method further comprising:
receiving a request to submit a FOIA request for information of at least one particular government institution of the one or more particular government institutions;
accessing FOIA request information that is usable to generate a FOIA request for information of the at least one particular government institution;
generating, based on the request and the FOIA request information, the FOIA request for the information of the at least one particular government institution;
submitting the FOIA request for the information of the at least one particular government institution;
receiving, in response to the FOIA request, the information of the at least one particular government institution; and
providing the information of the at least one particular government institution for display.

16. The one or more non-transitory computer-readable media of claim 11 wherein receiving the multiple sets of data for the multiple government institutions includes obtaining, using multiple web crawlers, the multiple sets of data for the multiple government institutions from multiple government data systems.

17. The one or more non-transitory computer-readable media of claim 11, the method further comprising:
receiving a request to add one or more intent scores for the one or more particular government institutions to the workspace;
generating, based on the request, one or more inputs to the one or more artificial intelligence models, the one or more inputs including one or more requests to generate the one or more intent scores;
receiving one or more responses from the one or more artificial intelligence models, the one or more responses including the one or more intent scores; and
adding the one or more intent scores for the one or more particular government institutions to the workspace.

18. The one or more non-transitory computer-readable media of claim 11 wherein the request to add data to the workspace for the one or more particular government institutions includes a prompt, and generating, based on the request, the one or more inputs for the one or more artificial intelligence models includes generating, based on the prompt, the one or more inputs for the one or more artificial intelligence models.

19. The one or more non-transitory computer-readable media of claim 11, the method further comprising:
receiving multiple requests for proposal for at least some of the multiple government institutions;
storing the multiple requests for proposal;
receiving a search request to search the multiple requests for proposal;
identifying, based on the search request, one or more particular requests for proposal of the multiple requests for proposal; and
providing the one or more particular requests for proposal for display.

20. A system comprising at least one processor and at least one memory including executable instructions that when executed by the at least one processor cause the system to:
receive multiple sets of data for multiple government institutions, a set of data for a government institution including profile data of the government institution and one or more of contact information of one or more individuals associated with the government institution, one or more meeting materials of the government institution, or one or more budgets of the government institution;
for each set of data of the multiple sets of data:
generate, based on the data in the set, multiple data segments;
generate, based on the multiple data segments, multiple vectors, a vector representing a data segment; and
store the multiple data segments and the multiple vectors;
receive a request to generate a workspace that includes one or more particular government institutions of the multiple government institutions;
generate the workspace, the workspace including the one or more particular government institutions and the profile data of the one or more particular government institutions;
provide the workspace for display;
receive a request to add data for the one or more particular government institutions to the workspace;
generate, based on the request, a search vector;
identify based on the search vector, one or more particular vectors of the multiple vectors;
identify, based on the one or more particular vectors, one or more particular data segments of the multiple data segments;
generate, based on the request, one or more inputs for one or more artificial intelligence models;
provide the one or more inputs and the one or more particular data segments to the one or more artificial intelligence models;
receive one or more responses from the one or more artificial intelligence models;
generate, based on the one or more responses, the data for the one or more particular government institutions; and
add the data for the one or more particular government institutions to the workspace.
